(19) United States
(12) Patent Application Publication
(10) Pub. No.: US 2006/0241237 A1
(43) Pub. Date: Oct. 26, 2006

(54) Continuous process for producing exfoliated nano-graphite platelets

(75) Inventors: Lawrence T. Drzal, Okemos, MI (US); Hiroyuki Fukushima, Lansing, MI (US); Brian Rook, Holt, MI (US); Michael Rich, Williamston, MI (US)

Correspondence Address: Ian C. McLeod;McLeod & Moyne, P.C., 2190 Commons Parkway, Okemos, MI, 48864, US

(73) Assignee: Board of Trustees of Michigan State University, East Lansing, MI (US)

(21) Appl. No.: 11/435,350

(22) Filed: May 16, 2006

Related U.S. Application Data
(63) Continuation-in-part of application No. 10/659,577, filed on Sep. 10, 2003.
(60) Provisional application No. 60/410,263, filed on Sep. 12, 2002.

(51) Int. Cl. C08K 3/04; A62D 3/00

(52) U.S. Cl. 524/495; 204/157.43

(57) ABSTRACT

Graphite nanoplatelets of expanded graphite and composites and products produced therefrom are described. The graphite is expanded by microwaves or radiofrequency waves in the presence of a gaseous atmosphere. Various devices are described for expanding the intercalated graphite by means of microwaves or other radiofrequency waves to produce the expanded graphite. These devices can be used in a continuous process.

### CROSS-REFERENCE TO RELATED APPLICATION

This application is a continuation-in-part of U.S. application Ser. No. 10/659,577 filed Sep. 10, 2003 which claims priority to U.S. Provisional Application Ser. No. 60/410,263, filed Sep. 12, 2002.

### STATEMENT REGARDING FEDERALLY SPONSORED RESEARCH OR DEVELOPMENT

Not applicable.

Reference to a “Computer Listing Appendix submitted on a Compact Disc”

Not Applicable.

### BACKGROUND OF THE INVENTION

(1) Field of the Invention

Methods of rapidly and inexpensively converting intercalated graphite into exfoliated graphite are provided in the present invention. The graphite is expanded by a continuous process preferably by microwave or radiofrequency wave heating. The present invention relates in part to polymer-expanded graphite composites.

(2) Description of Related Art

Graphite is a well known material occurring in natural and synthetic form and is well described in the literature. Illustrative of this art is a monograph by Michel A. Boucher, Canadian Minerals Yearbook 24.1-24.9(1994).

Nanocomposites composed of polymer matrices with reinforcements of less than 100 nm in size, are being considered for applications such as interior and exterior accessories for automobiles, structural components for portable electronic devices, and films for food packaging (Giannelis, E. P., Appl. Organometallic Chem., Vol. 12, pp. 675 (1998); and Pinnavaia, T. J. et al., Polymer Clay Nanocomposites. John Wiley & Sons, Chichester, England (2000)). While most nanocomposite research has focused on exfoliated clay platelets, the same nanoreinforcement concept can be applied to another layered material, graphite, to produce nanoplatelets and nanocomposites (Pan, Y. X., et al., J. Polym. Sci., Part B: Polym. Phy., Vol. 38, pp. 1626 (2000); and Chen, G. H., et al., J. Appl. Polym. Sci. Vol. 82, pp. 2506 (2001)). Graphite is the stiffest material found in nature (Young's Modulus=1060 MPa), having a modulus several times that of clay, but also with excellent, electrical and thermal conductivity.

A useful form of graphite is expanded graphite which has been known for years. The first patents related to this topic appeared as early as 1910 (U.S. Pat. Nos. 1,137,373 and 1,191,383). Since then, numerous patents related to the methods and resulting expanded graphites have been issued. For example, many patents have been issued related to the expansion process (U.S. Pat. Nos. 4,915,925 and 6,149,972), expanded graphite-polymer composites (U.S. Pat. Nos. 4,530,949, 4,704,231, 4,946,892, 5,582,781, 4,091,083 and 5,846,459), flexible graphite sheet and its fabrication process by compressing expanded graphite (U.S. Pat. Nos. 3,404,061, 4,244,934, 4,888,242, 4,961,988, 5,149,518, 5,294,300, 5,582,811, 5,981,072 and 6,143,218), and flexible graphite sheet for fuel cell elements (U.S. Pat. No. 5,885,728 and 6,060,189). Also there are patents relating to grinding/pulverization methods for expanded graphite to produce fine graphite flakes (U.S. Pat. Nos. 6,287,694, 5,330,680 and 5,186,919). All of these patents use a heat treatment, typically in the range of 600° C. to 1200° C., as the expansion method for graphite. The heating by direct application of heat generally requires a significant amount of energy, especially in the case of large-scale production. Radiofrequency (RF) or microwave expansion methods can heat more material in less time at lower cost. U.S. Pat. No. 6,306,264 to Kwon et al. discusses microwave as one of the expansion methods for SO₃ intercalated graphite in solution.

U.S. Pat. No. 5,019,446 and 4,987,175 describe graphite flake reinforced polymer composites and the fabrication method. These patents did not specify the methods to produce thin, small graphite flakes. The thickness (less than 100 nm) and aspect ratio (more than 100) of the graphite reinforcement was described.

Many patents have been issued related to anode materials for lithium-ion or lithium-polymer batteries (U.S. Pat. Nos. 5,344,726, 5,522,127, 5,591,547, 5,672,446, 5,756,062, and 6,136,474). Among these materials, one of the most widely investigated and used is graphite flakes with appropriate size, typically 2 to 50 μm, with less oxygen-containing functional groups at the edges. Most of the patents described graphite flakes made by carbonization of precursor material, such as petroleum coke or coal-tar pitch, followed by graphitization process.

U.S. Pat. No. 4,777,336 to Asmussen et al., U.S. Pat. No. 5,008,506 to Asmussen, U.S. Pat. No. 5,770,143 to Hawley et al., and U.S. Pat. No. 5,884,217 to Hawley et al. describe various microwave or radiofrequency wave systems for heating a material. These applications and patents are hereby incorporated herein by reference in their entirety.

### SUMMARY OF THE INVENTION

An important aspect of utilizing graphite as a platelet nanoreinforcement is in the ability to expand this material. With surface treatment of the expanded graphite, its dispersion in a polymer matrix results in a composite with not only excellent mechanical properties but electrical properties as well, opening up many new structural applications as well as non-structural ones where electromagnetic shielding and high thermal conductivity are requirements. In addition, graphite nanoplatelets are approximately 500 times less expensive than carbon nanotubes.

Thus the present invention relates in part to a composite material which comprises: finely divided expanded graphite consisting essentially of single platelets which are less than 200 microns in length; and a polymer having the expanded graphite platelets dispersed therein.

In particular, the present invention relates to a composite material which comprises: finely divided expanded graphite having single platelets with a length less than about 300 microns and a thickness of less than about 0.1 microns (preferably with a thickness less than about 20 nm, and more preferably less than about 15 nm); and a polymer having the expanded graphite particles dispersed therein, wherein the composite material contains up to 50% by volume of the graphite platelets. Preferably the expanded graphite platelets are present in an amount so that composite material is conductive.

A graphite precursor containing a chemical which was vaporized by heat to form the expanded graphite. In most cases, the chemical should be removed, preferably by heating, from the graphite by sufficient heating before mixing with polymers, since the chemical can degrade polymers. Preferably the expanded graphite has been formed in a radiofrequency wave applicator by heating the graphite precursor with the radiofrequency waves. Preferably a precursor graphite has been treated with a fuming oxy acid and heated to form the expanded graphite particles. Good results have been achieved with expanded graphite composites surface treated with acrylamide or other surface modifying treatments.

The composite material can be applied to thermoset polymer systems, such as epoxy, polyurethane, polyurea, polysiloxane and alkyds, where polymer curing involves coupling or crosslinking reactions. The composite material can be applied as well to thermoplastic polymers for instance polyamides, proteins, polyesters, polyethers, polyurethanes, polysiloxanes, phenol-formaldehydes, urea-formaldehydes, melamine-formaldehydes, celluloses, polysulfides, polyacetals, polyethylene oxides, polycaprolactams, polycaprolactons, polylactides, polyimides, and polyolefins (vinyl-containing thermoplastics). Specifically included are polypropylene, nylon and polycarbonate. Thermoplastic elastomers, such as PET (polyethylene telephthalate) can also be used. The polymer can be for instance an epoxy resin. The epoxy resin cures when heated. The epoxy composite material preferably contains less than about 8% by weight of the expanded graphite platelets. Thermoplastic polymers are widely used in many industries. The expanded graphite can also be incorporated into ceramics and metals.

Further the present invention relates to a method for preparing a shaped composite which comprises: providing a mixture of a finely divided expanded graphite consisting essentially of single platelets which are essentially less than 200 microns in length and with a polymer precursor with the expanded platelets dispersed therein; and forming the shaped composite material from the mixture.

Further, the present invention relates to a method for preparing a shaped composite material which comprises: providing a mixture of an expanded graphite having single platelets with a length less than about 300 microns and a thickness of less than about 0.1 microns with a polymer precursor with the expanded graphite platelets dispersed therein, wherein the composite material contains up to about 50% by volume of the expanded graphite platelets; and forming the shaped composite material from the mixture.

Preferably the expanded graphite is provided in the polymer in an amount sufficient to render the shaped composite conductive. Preferably the expanded graphite has been expanded with expanding chemical which can be evaporated upon application of heat. Preferably the expanded graphite platelets are formed in a radiofrequency wave applicator by heating the graphite precursor with radiofrequency waves and then the expanding chemical is removed to form the graphite precursor. Preferably a graphite precursor is treated with a fuming oxy acid and heated to provide the expanded graphite particles.

The present invention also relates to an improvement in a battery containing ions in the anode which comprises a finely divided microwave or RF expanded graphite having single platelets with a length less than about 300 microns and a thickness of less than about 0.1 microns.

The present invention also relates to an improvement in a catalytic conversion of an organic compound to hydrogen with a catalytic material deposited on a substrate the improvement in the substrate which comprises a finely divided microwave or RF expanded graphite having single particles with a length less than about 300 microns and a thickness of less than about 0.1 microns.

Finally the present invention relates to a process for producing platelets of expanded graphite which comprises: expanding graphite intercalated with a chemical which expands upon heating to produce expanded graphite platelets; and reducing the expanded graphite platelets so that essentially all of the individual platelets are less than 200 microns in length, 0.1 micron in thickness. Preferably the chemical agent is an inorganic oxy acid. Preferably the expanding is by microwave or RF heating. Preferably the graphite is surface modified such as with acrylamide.

Specifically, the present invention provides an apparatus for expanding unexpanded intercalated graphite in the presence of a gaseous atmosphere with a chemical which expands upon heating to produce expanded graphite which comprises: a microwave or radiofrequency applicator with a chamber for expanding the intercalated unexpanded graphite; feed means for feeding the intercalated unexpanded graphite into the chamber; sorting means in the chamber for differentiating between the expanded graphite and the intercalated unexpanded graphite; exit means from the chamber for receiving the expanded graphite from the sorting means with exclusion of the intercalated unexpanded graphite; and optionally a recycling means for retreating the intercalated unexpanded graphite in the chamber of the applicator.

Further embodiments provide continuous feed and expansion of the intercalated unexpanded graphite between the feed opening means and the exit means. In further embodiments, the recycling means further comprises a speed control which can adjust the residence time of the graphite in the chamber of the microwave or radiofrequency applicator. In still further embodiments, the feed means comprises a vibratory-type feeder, gravimetric feeder, volumetric auger-type feeder, injector, flowing fluid suspension, dripping fluid suspension, blower, compressed gas feeder, vacuum feeder, gravity feeder, conveyor belt feeder, drum feeder, wheel feeder, slide, chute, or combination thereof. In still further embodiments, the sorting means sorts the expanded graphite from the expanded intercalated graphite based upon a size difference.

The present invention further provides an apparatus for expanding unexpanded intercalated graphite in the presence of a gaseous atmosphere with a chemical which expands upon heating to produce expanded graphite which comprises: a microwave or radiofrequency applicator with a chamber for expanding the intercalated unexpanded graphite; an internal rotatable plate for supporting the intercalated unexpanded graphite by the microwaves or radiofrequency waves; feed means at an upper portion of the applicator for feeding the intercalated unexpanded graphite by gravity onto the plate; wiper means mounted in the chamber for selectively separating the expanded graphite from the intercalated unexpanded graphite as the plate rotates; chute means leading from the chamber of the applicator for selectively removing the expanded graphite by gravity from the chamber which has been selectively separated by the wiper means; and a container for receiving the expanded graphite from the chute means.

Further embodiments provide continuous production of the expanded graphite between the feed means and the container. Some embodiments further comprise one or more speed control means for controlling residence time of the graphite in the chamber of the microwave or radiofrequency applicator. In further embodiments, the feed means comprises a vibratory-type feeder, gravimetric feeder, volumetric auger-type feeder, injector, flowing fluid suspension, dripping fluid suspension, blower, compressed gas feeder, vacuum feeder, gravity feeder, conveyor belt feeder, drum feeder, wheel feeder, slide, chute, or combination thereof. In still further embodiments, the wiper means comprises a stationary or moving wiper plate.

The present invention further provides an apparatus for expanding unexpanded intercalated graphite in the presence of a gaseous atmosphere with a chemical which expands upon heating to produce expanded graphite which comprises: a microwave or radiofrequency applicator with a chamber for expanding the intercalated unexpanded graphite; feed means for feeding the intercalated unexpanded graphite into the chamber of the applicator; conveying means for moving the intercalated unexpanded graphite through the chamber while exposing the graphite to microwaves or radiofrequency waves generated by the applicator so as to expand the graphite to produce expanded graphite; and removing means leading from the chamber of the applicator to remove the expanded graphite from the chamber.

In further embodiments, the feed means further comprises a feed rate control mechanism. In still further embodiments, the conveying means further comprises a conveyor speed control mechanism. In further still embodiments, the feed means comprises a vibratory-type feeder, gravimetric feeder, volumetric auger-type feeder, injector, flowing fluid suspension, dripping fluid suspension, blower, compressed gas feeder, vacuum feeder, gravity feeder, conveyor belt feeder, drum feeder, wheel feeder, slide, chute, or combination thereof. In further still embodiments, the conveying means comprises a conveyor belt, rotating plate (carousel), auger (screw conveyor), gravity, aerosol cloud, dynamic air circulation, electric field, or combination thereof. In still further embodiments, the apparatus further comprises a collecting means for receiving the expanded graphite from the removal means. In further embodiments, the collecting means comprises a bulk container, belt, wheel, sheet, fabric, fluid suspension, paste, slurry, vacuum bag, woven fibers, non-woven fibers, mat, or combination thereof.

The present invention further provides a method for expanding unexpanded intercalated graphite in the presence of a gaseous atmosphere with a chemical which expands upon heating to produce expanded graphite which comprises: providing an apparatus comprising a microwave or radiofrequency applicator with a chamber for expanding the intercalated unexpanded graphite; feed means for feeding the intercalated unexpanded graphite into the chamber; sorting means in the chamber for differentiating between the expanded graphite and the intercalated unexpanded graphite; exit means from the chamber for receiving the expanded graphite from the sorting means with exclusion of the intercalated unexpanded graphite; and recycling means for retreating the intercalated unexpanded graphite in the chamber of the applicator; feeding unexpanded intercalated graphite into the feed means; exposing the unexpanded intercalated graphite in the gaseous atmosphere to microwave or radiofrequency energy in the chamber of the apparatus to produce the expanded graphite; and collecting the expanded graphite from the exit means.

Further embodiments of the method provide a continuous feed and expansion of the intercalated unexpanded graphite between the feed opening means and the exit means. In further embodiments, the recycling means further comprises a speed control which can adjust the residence time of the graphite in the chamber of the microwave or radiofrequency applicator. In still further embodiments, the feed means comprises a vibratory-type feeder, gravimetric feeder, volumetric auger-type feeder, injector, flowing fluid suspension, dripping fluid suspension, blower, compressed gas feeder, vacuum feeder, gravity feeder, conveyor belt feeder, drum feeder, wheel feeder, slide, chute, or combination thereof. In further embodiments, the sorting means sorts the expanded graphite from the expanded intercalated graphite based upon a size difference.

The present invention further provides a continuous method for expanding unexpanded intercalated graphite in the presence of a gaseous atmosphere (air, N₂, inert gas, etc.) with a chemical which expands upon heating to produce expanded graphite which comprises: providing an apparatus comprising a microwave or radiofrequency applicator with a chamber for expanding the intercalated unexpanded graphite; an internal rotatable plate for supporting the intercalated unexpanded graphite by the microwaves or radiofrequency waves; feed means at an upper portion of the applicator for feeding the intercalated unexpanded graphite by gravity onto the plate; wiper means mounted in the chamber for selectively separating the expanded graphite from the unexpanded intercalated graphite as the plate rotates; chute means leading from the chamber of the applicator for selectively removing the expanded graphite by gravity from the chamber which has been selectively separated by the wiper means; and a container for receiving the expanded graphite from the chute means; feeding unexpanded intercalated graphite into the feed means; exposing the unexpanded intercalated graphite in the gaseous atmosphere to microwave or radiofrequency energy in the chamber of the apparatus to produce the expanded graphite; and collecting the expanded graphite from the container.

Further embodiments of the method provide continuous production of the expanded graphite between the feed means and the container. In further embodiments, the apparatus further comprises a one or more speed control means for controlling residence time of the graphite in the chamber of the microwave or radiofrequency applicator. In still further embodiments, the feed means comprises a vibratory-type feeder, gravimetric feeder, volumetric auger-type feeder, injector, flowing fluid suspension, dripping fluid suspension, blower, compressed gas feeder, vacuum feeder, gravity feeder, conveyor belt feeder, drum feeder, wheel feeder, slide, chute, or combination thereof. In further embodiments, the wiper means comprises a stationary or moving wiper plate.

The present invention further provides a continuous method for expanding unexpanded intercalated graphite in the presence of a gaseous atmosphere with a chemical which expands upon heating to produce expanded graphite which comprises: providing an apparatus comprising a microwave or radiofrequency applicator with a chamber for expanding the intercalated unexpanded graphite; feed means for feeding the intercalated unexpanded graphite into the chamber of the applicator; conveying means for moving the intercalated unexpanded graphite through the chamber while exposing the graphite to microwaves or radiofrequency waves generated by the applicator so as to expand the graphite to produce expanded graphite; and removing means leading from the chamber of the applicator to remove the expanded graphite from the chamber; feeding unexpanded intercalated graphite into the feed means; exposing the unexpanded intercalated graphite in the gaseous atmosphere to microwave or radiofrequency energy in the chamber of the apparatus to produce the expanded graphite; and collecting the expanded graphite from the removing means.

In further embodiments, the feed means further comprises a feed rate control mechanism. In still further embodiments the conveying means further comprises a conveyor speed control mechanism. In still further embodiments, the feed means comprises a vibratory-type feeder, gravimetric feeder, volumetric auger-type feeder, injector, flowing fluid suspension, dripping fluid suspension, blower, compressed gas feeder, vacuum feeder, gravity feeder, conveyor belt feeder, drum feeder, wheel feeder, slide, chute, or combination thereof. In still further embodiments, the conveying means comprises a conveyor belt, rotating plate (carousel), auger (screw conveyor), gravity, aerosol cloud, dynamic air circulation, electric field, or combination thereof. In still further embodiments of the method, the expanded graphite is collected by a bulk container, belt, wheel, sheet, fabric, fluid suspension, paste, slurry, vacuum bag, woven fibers, non-woven fibers, mat, or combination thereof.

The present invention further provides a method for expanding unexpanded intercalated graphite in the presence of a gaseous atmosphere with a chemical which expands upon heating to produce expanded graphite which comprises: providing an apparatus comprising a microwave or radiofrequency applicator with a chamber for expanding the unexpanded intercalated graphite; providing unexpanded intercalated graphite in the chamber of the apparatus in the presence of a gaseous atmosphere; and exposing the unexpanded intercalated graphite in the gaseous atmosphere to microwave or radiofrequency energy in the chamber of the apparatus to produce the expanded graphite. In further embodiments, the method further comprises the step of pulverizing the expanded graphite to provide graphite platelets. In further still embodiments, the graphite platelets have a surface area of 50 m²/g or larger. In further still embodiments, the graphite platelets have a surface area of 75 m²/g or larger. In further still embodiments, the graphite platelets have a surface area of 100 m²/g or larger. In further still embodiments, the graphite platelets have an aspect ratio of 100 or higher. In further still embodiments, the graphite platelets have an aspect ratio of 1,000 or higher. In further still embodiments, the graphite platelets have an aspect ratio of 10,000 or higher.

### BRIEF DESCRIPTION OF THE DRAWINGS

FIG. 1 is a scanning electron microscope (SEM) of intercalated graphite flakes.

FIG. 2 is a SEM image of expanded natural graphite flakes wherein the flakes are expanded by microwave.

FIG. 3 is a graph of an x-ray diffraction pattern of intercalated natural graphite of FIG. 1. Some order is seen.

FIG. 4 is a graph of an x-ray diffraction pattern of the expanded natural graphite of FIG. 2. No order is seen.

FIG. 5 is a SEM of pulverized exfoliated (expanded) natural graphite.

FIG. 6 is a graph showing the size distribution of the particles of FIG. 5 after being pulverized.

FIGS. 7 is a graph showing the flexural modulus of cured epoxy resins containing 3% by volume of the pulverized graphite particles of FIG. 5 and FIG. 6.

FIG. 8 is a graph showing the strength of cured epoxy resins containing 3% by volume of the pulverized graphite particles of FIG. 5 and FIG. 6.

FIG. 9 is a graph of the resistivity of control and graphite nanoplatelet reinforced composites of FIGS. 7 and 8 as a function of volume percent exfoliated graphite (Gr).

FIGS. 10A and 10B are TEM images of graphite nanoplatelets in the polymer matrix of FIGS. 7 and 8.

FIG. 11 is a graph showing flexural strength versus expanded graphite content for acrylamide grafted graphite.

FIG. 12 is a graph showing flexural modulus versus acrylamide grafted expanded graphite content for acrylamide grafted graphite.

FIGS. 13, 14, 15, 16, 17 and 18 are graphs showing flexural strength and modulus for acrylamide modified graphite and various carbon materials. “MW” is microwave, and “AA” is acrylamide.

FIGS. 19, 20 and 21 are SEM images of various carbon materials. FIG. 19 is PAN based carbon fiber, FIG. 20 is carbon film and FIG. 21 is carbon black.

FIGS. 22, 23 and 24 are SEM images showing graphite in various forms.

FIGS. 25 and 26 are TEM images of graphite nanoplatelets.

FIGS. 27 and 28 are graphs showing size distribution of graphite microplates and graphite nanoplatelets.

FIGS. 29 and 30 are graphs comparing flexural strength and modulus for various samples including graphite modified with acrylamide.

FIGS. 31 and 32 are graphs of flexural strength and modulus for various carbon containing materials versus acrylamide grafting.

FIG. 33 is a graph showing coefficient of thermal expansion (CTE) of various composites with 3% by volume reinforcements and without reinforcement.

FIG. 34 is a graph showing T_{g} for various composites with 3% volume percent of reinforcements and without reinforcements.

FIG. 35 is a graph showing electrical resistivity of the components versus percentage of reinforcement by weight.

FIG. 36 is a graph showing electrical percolation threshold for various composites as a function of weight percent.

FIG. 37 is a graph showing impact strength for various composites.

FIG. 38 is a separated perspective view of the basic structure of a polymer battery. Cathode and Anode: electrically conducting polymer on substrate. Polymer gel electrolytes: Ionically conducting polymer gel film.

FIG. 39 is a schematic view of the basic structure of a fuel cell.

FIG. 40 is a schematic view of the basic structure of a lithium ion-battery.

FIG. 41 is an illustration of one embodiment of a continuous carousel type microwave apparatus 10 of the present invention.

FIG. 42 is a top view taken along line 2-2 of the wiper blade 40 and rotatable plate 33 of the apparatus 10 of FIG. 41.

FIG. 43 is an illustration of one embodiment of a continuous screw conveyor type microwave apparatus 110 of the present invention.

FIG. 44 is an illustration of one embodiment of a continuous belt conveyor type microwave apparatus 210 of the present invention.

FIG. 45 is an illustration of one embodiment of a continuous blower type microwave apparatus 310 of the present invention.

FIG. 46 is an illustration of a simple embodiment of a method of expanding intercalated graphite in batch mode within a microwave apparatus 410 while in a gaseous atmosphere.

FIG. 47 is an illustration of expanding graphite 510 in a gaseous atmosphere.

### DESCRIPTION OF PREFERRED EMBODIMENTS

All patents, patent applications, government publications, government regulations, and literature references cited in this specification are hereby incorporated herein by reference in their entirety. In case of conflict, the present description, including definitions, will control.

Graphite is a layered material. Individual molecular layers are held together with weak Van der Waals forces which are capable of intercalation with organic or inorganic molecules and eventual expansion. These nanosized expanded graphite platelet materials are very large platelets having large diameters and are very thin in thickness. The graphite structure is stiff in bending. Graphite is a very good thermal and electrical conductor.

Expanded graphite provides superior mechanical properties and in addition provides electrical properties if a sufficient amount is present in a polymer matrix. Expanded graphite platelets have interbasal plane surfaces which have reactive sites on the edges of the platelets. Different chemical groups can be added to the edges. The application of an electric field can be used to orient the expanded graphite platelets in a preferred direction creating materials which are electrically or thermally conductive in one direction. Submicron conductive paths can be created to act as nanosized wires.

An expanded graphite is one which has been heated to separate individual platelets of graphite. An exfoliated graphite is a form of expanded graphite where the individual platelets are separated by heating with or without an agent such as a polymer or polymer component. In the present application the term “expanded graphite” is used. The expanded graphite usually does not have any significant order as evidenced by an x-ray diffraction pattern.

The use of microwave (MW) energy or radiofrequency (RF) induction heating provides a fast and economical method to produce expanded graphite nanoflakes, graphite nanosheets, or graphite nanoparticles. The microwave or RF methods are especially useful in large-scale production and are very cost-effective.

The combination of RF or microwave expansion and appropriate grinding technique, such as planetary ball milling (and vibratory ball milling), produces nanoplatelet graphite flakes with a high aspect ratio efficiently. The pulverized graphite has an aspect ratio of 100, 1000 or 10,000 or higher. The surface area of the pulverized graphite is 50 m²/g, 75 m²/g, or 100 m²/g or larger. Microwave or RF expansion and pulverization of the crystalline graphite to produce suitable graphite flakes enables control of the size distribution of graphite flakes more efficiently. By incorporating an appropriate surface treatment, the process offers an economical method to produce a surface treated expanded graphite.

Chemically intercalated graphite flakes are expanded by application of the RF or microwave energy. The expansion occurs rapidly. Heating for 3 to 5 minutes removes the expanding chemical. The graphite absorbs the RF or microwave energy very quickly without being limited by convection and conduction heat transfer mechanisms. The intercalant heats up past the boiling point and causes the graphite to expand to many times its original volume. The process can be performed continuously by using a commercially available induction or microwave system with conveyors. Although a commercial microwave oven operating at 2.45 GHz was used for the following experiments, radio frequency (induction heating) or microwave frequency energy across a wide range can be used for this purpose.

The expanded graphite is pulverized for instance by ball milling, mechanical grinding, air milling, or ultrasonic wave to produce graphite flakes (platelets) with high aspect ratio. These flakes are used as reinforcements in various matrices including polymers and metals. Also these flakes can be used, for instance, as anode materials, or substrates for metal catalysts. The exfoliated graphite flakes can be provided in a polymer matrix composite to improve the mechanical, electrical and thermal properties.

In some embodiments the intercalated graphite flakes are expanded by application of microwave energy at 2.45 GHz. This process can be done continuously by using a commercially available microwave system with conveyors or the other devices as described herein. After the expansion, the graphite material is calendared, with or without binder resins, to form a flexible graphite sheet. The resultant sheet is cut into various sizes and shapes and used as gaskets, sealing material, electrode substrates, and separators for fuel cells. Applications for the expanded graphite include thermally, electrically and structural nanoreinforcements for polymers and metals, electrode substrates for batteries, separators for fuel cells, anode material, or substrates for metal catalysts.

Specifically, the present invention provides a method for rapidly and inexpensively converting intercalated graphite into exfoliated graphite nanoplatelets utilizing microwave heating. The disclosed process vastly improves the production rate of exfoliated graphite. Prior to this novel invention, the slow speed of batch processed exfoliated graphite at elevated temperatures had been a barrier to an industrial scale-up of exfoliated graphite production. The application of this invention removes this practical barrier, and can thus help to facilitate future industrialet applications for exfoliated nano-graphite platelets on a mass-production scale. The present invention can include means to control the residence time of the graphite particles in the microwave devices by various mechanisms.

The use of exfoliated nanographite platelets has been demonstrated to produce platelet type nanomaterials which have several advantages in many applications. Significant improvements can be obtained in high performance composites based on unidirectional or woven fibers, such as carbon fiber, glass fiber, and aramid fiber, when these material are added to concentration below 5%. Addition of the material to plastics, imparts electrical conductivity, thermal conductivity, barrier properties, scratch and mar resistance, increased stiffness and strength and toughness, reduced flammability and improved processability. The exfoliated nanographite has the capability of improving lithium (Li) ion battery performance, fuel cell operation and hydrogen storage. The invention of this process will create the ability to manufacture this material for these application and a much lower cost than alternative materials. Markets that utilize multifunctional plastics and composite materials (e.g. aerospace, electronics, transportation, infrastructure, housing, etc.) would be interested in using this cost effective additive nanomaterial and this process.

### EXAMPLE 1

The graphite was expanded before the polymer is introduced. Intercalated graphite flakes were expanded by exposure to microwave energy, typically at 2.45 GHz frequency, for a few seconds to a few minutes in an oven. This process can be done continuously by using commercially available microwave systems with conveyors as described herein or batch-style process using individual microwave ovens. An automated continuous system is preferred from an economical point of view. In this case, the intercalated graphite flakes are first dispersed on a conveyor and introduced into the microwave oven, then processed under controlled conditions. Before or during this process additional chemicals/additives can be added to the intercalated graphite flakes to enhance the exfoliation, and/or apply surface treatments to the graphite flakes. After this process, washing and drying processes are applied, if necessary.

Typical starting materials are natural graphite flakes intercalated with oxidizing agents, but synthetic graphite, kish graphite, or the like can also be used. A preferred intercalating agent is a mixture of sulfuric acid or sulfuric acid/phosphoric acid mixture and an oxidizing agent such as nitric acid, perchloric acid, chromic acid, potassium chlorate potassium permanganate, potassium dichromate, hydrogen peroxide, metal halides or the like.

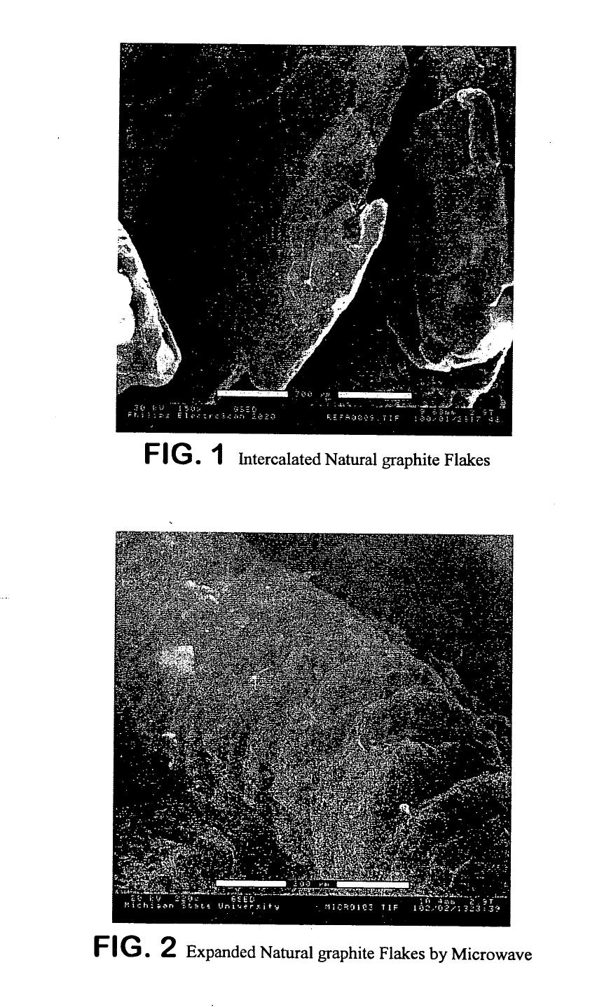

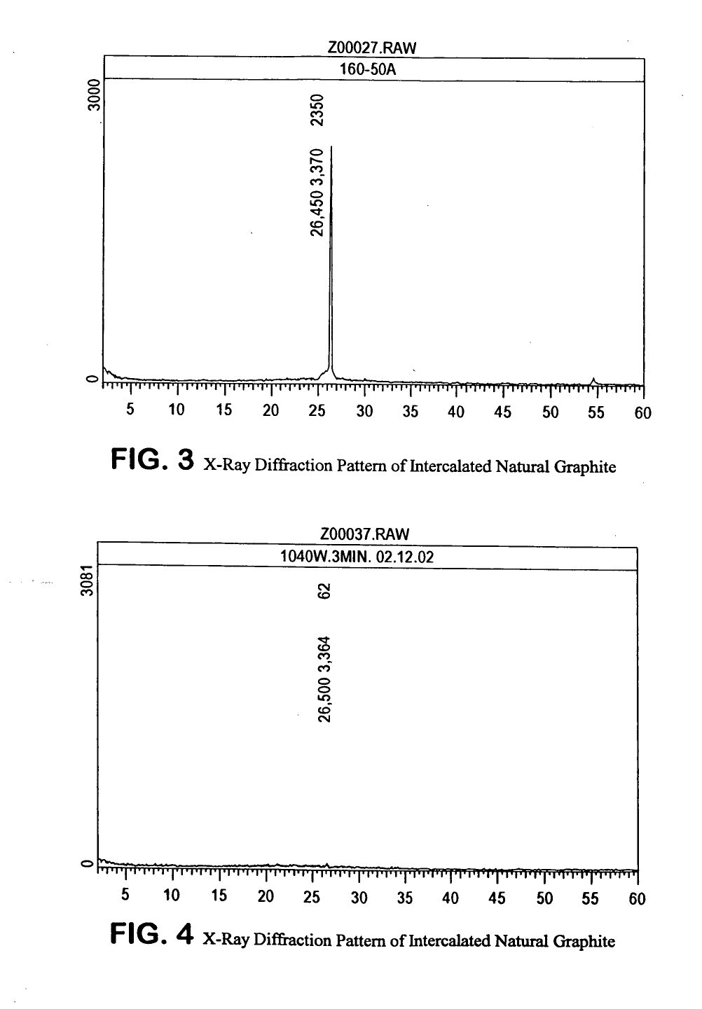

FIG. 1 shows a SEM image of intercalated natural graphite flakes. The microwave process heated the graphite flake, thereby heating the intercalated acid causing a rapid expansion of the graphite flakes perpendicular to the basal planes. During the process, the flakes expanded as much as 300 times or more, but still many of the layers were attached together and form worm-like shapes. FIG. 2 shows a SEM image of expanded graphite material. FIG. 3 and FIG. 4 show XRD data of intercalated natural graphite and expanded graphite processed by the microwave process. As FIG. 4 shows, the x-ray diffraction peak due to the highly and closely aligned graphite sheets was significantly reduced because of the expansion of the intercalated graphite by the microwave process. The expanded graphite can be pressed to form flexible graphite sheet. The thickness of the sheet can be controllable, depending on the application.

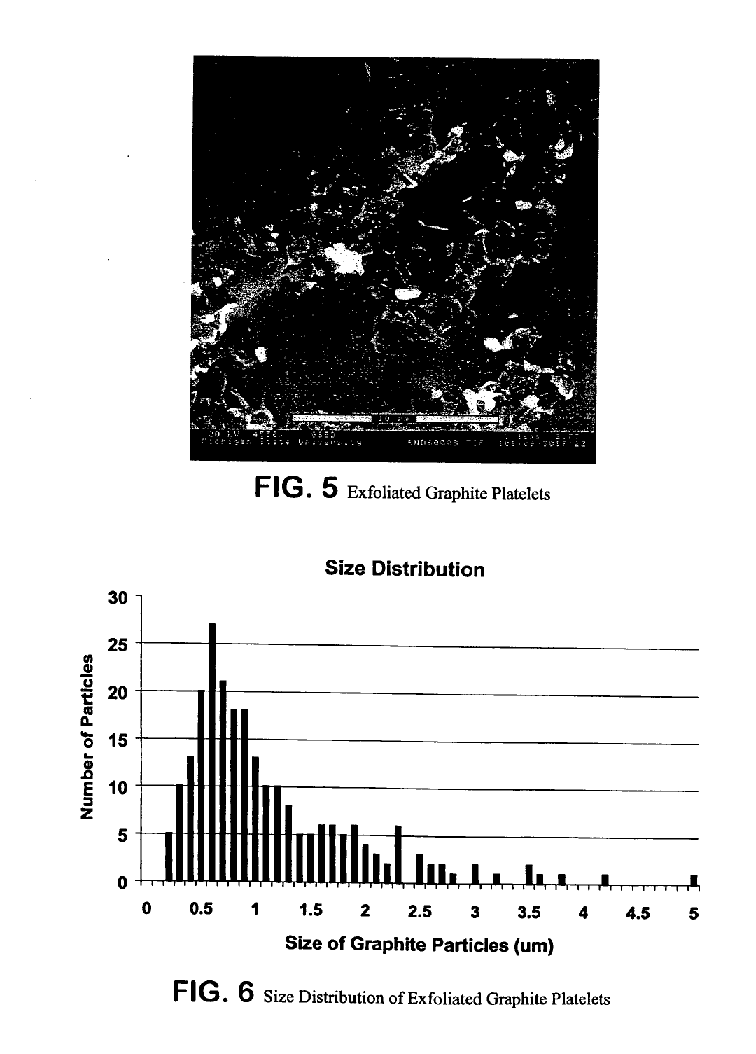

The expanded graphite was pulverized into the small platelets which have been crushed. FIG. 5 and FIG. 6 show a SEM image and size distribution of expanded graphite platelets. The size of most graphite particles is 1 μm or less after milling.

After the expansion, the graphite material can then be pressed into sheet or pulverized into small flakes. In the former case, the expanded graphite flakes are pressed by calendar roll, press machine, or any other press methods, with or without binder resins, to form a flexible graphite sheet. The resulting sheet can be cut into various sizes and shapes and can be used as gaskets, sealing material, electrode substrates, separators in fuel cells or many other applications. In the latter case, the expanded graphite flakes are pulverized by ball milling, planetary milling, mechanical grinding, air milling, ultrasonic processing or any other milling methods to produce graphite flakes with a high aspect ratio. These expanded flakes can also be given further surface treatments and can be used as reinforcements in various matrices including polymers, ceramics, and metals. Also these flakes and/or sheets can be used as electrodes and/or other parts for batteries, or electrodes, separators, and/or other parts materials for fuel cells, or substrates for various catalysts in many chemical/biological reactions.

The expanded graphite nanoplatelets can be incorporated into various types of matrices, including thermoplastic and thermoset polymers. Before mixing with the polymeric matrix, surface treatments can be applied to the graphite nanoplatelets to enhance the adhesion between graphite platelets and matrix and the dispersion of the platelets in the polymer. An example of composite fabrication and its properties is described below.

### EXAMPLE 2

Graphite flake that has been treated in the sulfuric acid to intercalate the graphite with sulfuric acid in between the layers was used. A commercial source used in this invention is GRAFGUARD™ which is produced by UCAR Carbon Company (Lakewood, Ohio).

Samples of acidic, neutral or basic intercalated graphite (GRAFGUARD™ 160-50N, 160-50A or 160-50B from UCAR Carbon Company, Parma, Ohio) were mixed into pure epoxy resin such as diglycidylether of bisphenol-A (DGEBA) Shell Epon 828 or equivalent. The mixture was heated to temperatures of at least 200° C. at which time approximately the graphite experiences a 15% weight loss due to the release of the trapped sulfuric acid compounds. At the same time, the epoxy molecule entered the space between the graphite layers. A very large volume expansion was encountered which results in sorption of the epoxy in between the graphite layers. This expanded graphite was dry to the touch indicating that all of the epoxy has been sucked into the galleries between the platelets. After cooldown, further epoxy and a curing agent were added to this mixture and a composite material was fabricated. There are various other routes available to attain the same end point of removal of the sulfuric acid and intercalation of the epoxy or similar polymer monomer in-between the graphite layers. One way is to remove the acid from the expanded graphite by heating.

Samples were made and mechanical properties were measured to show that the graphite has been intercalated and exfoliated (expanded) by the polymer.

### EXAMPLE 3

Composite samples were fabricated using the following steps. First, 1, 2, or 3 vol % (1.9, 3.8 or 5.8 wt %) of the expanded graphite nanoplatelets of Example 2 were added into the epoxy systems. (Epoxide; Shell Chemicals, EPON™ 828 (DGEBA), Curing Agent: Huntsman Corporation, JEFFAMINE™ T403. The weight ratio of EPON™ 828 to JEFFAMINE™ T403 was 100 to 45.) Then the mixtures were cured by heating at 85° C. for 2 hours followed by 150° C. for 2 hours. The heating ramp rate was 3° C. per min. At the same time, a reference system was made that did not have expanded graphite platelets in it but was composed of the same epoxy system from the same batch. The mechanical properties of these samples were determined. These samples were investigated by flexural test. Also, the AC conductivity of these materials was measured.

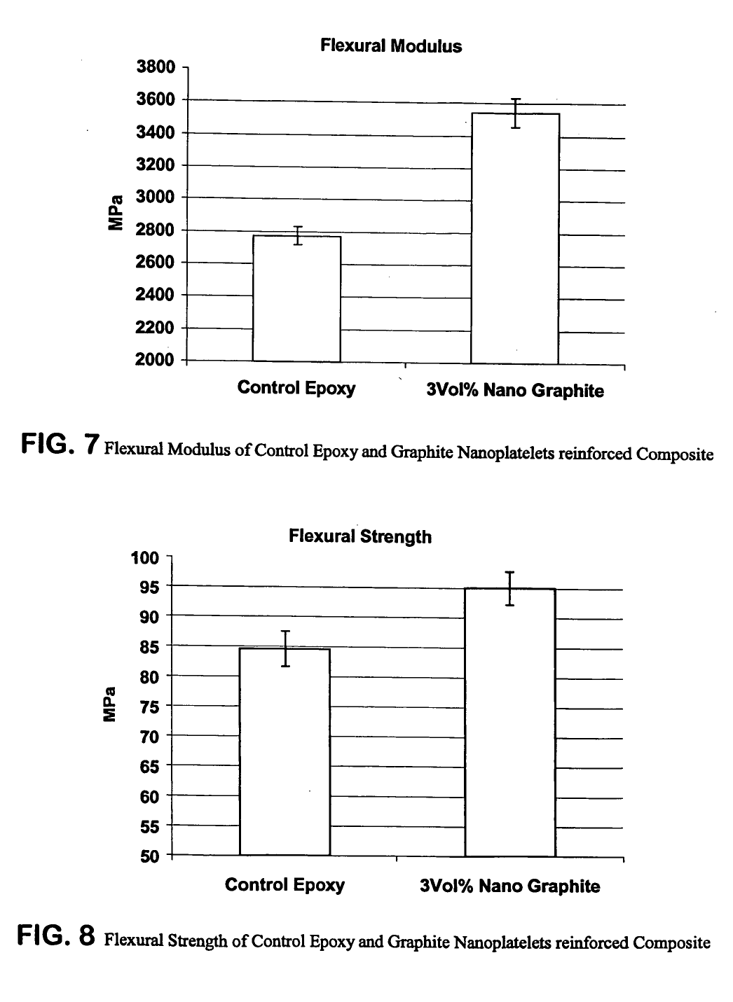

FIGS. 7 and 8 show the results of the flexural test. The composite materials with 3 vol % graphite showed about 28% of improvement in modulus and 12% improvement in strength compared to the matrix material. This is an excellent increase with respect to the relatively small amount of platelets reinforcements added to the system.

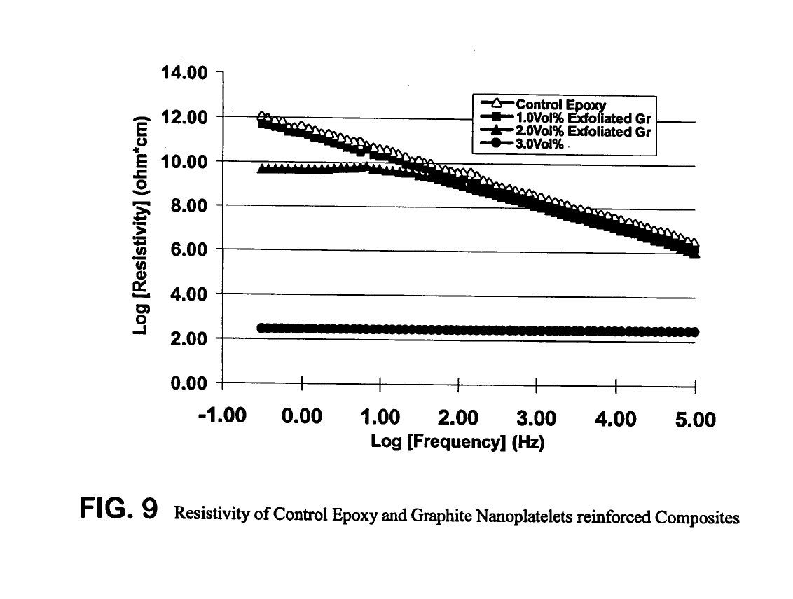

FIG. 9 shows the AC resistivity of the control epoxy and the graphite nanoplatelet reinforced composites. With 2% weight of graphite platelets, the composite began displaying some conductivity, which means that percolation threshold of this material exists around 2% weight percent (1% in value). With 3% volume graphite platelets, the composite shows a reduction of about 10 orders of magnitude which is a low enough resistivity for electrostatic dissipation or electrostatic painting applications.

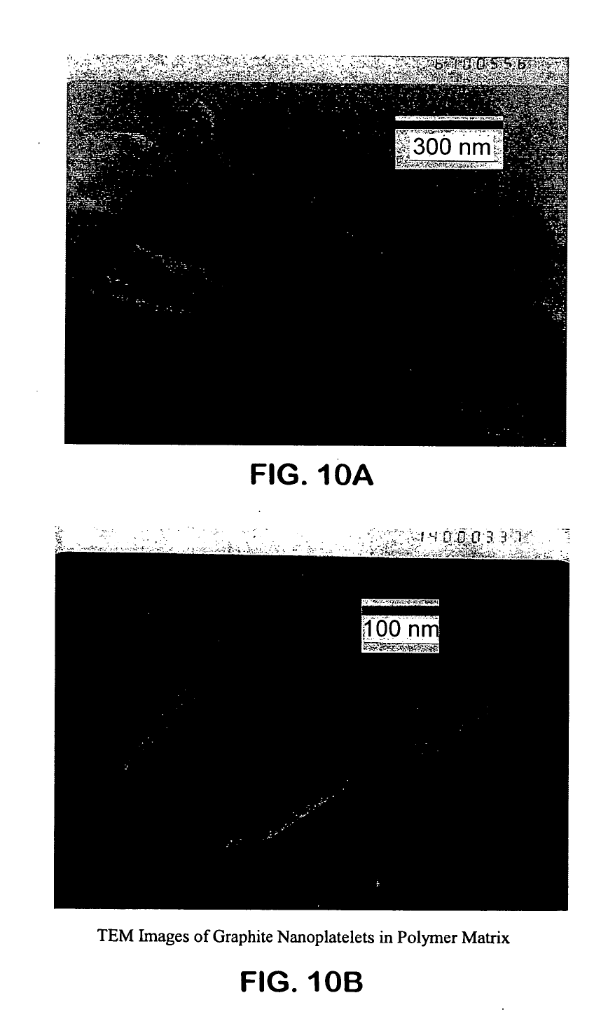

The microstructure of the composite was observed by preparing microtomed samples and viewing them in the transmission electron microscope (TEM). The images are shown in FIGS. 10A and 10B. According to these images, the thickness of these nanoplatelets was estimated around 1 to 30 nm. Multiple treatments by the microwave process can reduce the platelet thickness to much smaller dimensions.

### EXAMPLE 4

This Example shows acrylamide grafting on a microwaved and milled graphite platelet. The objective was to demonstrate the mechanical properties of composites reinforced with acrylamide grafted graphite nanoplatelets.

The graphite sample was microwave-exfoliated and vibratory milled. The vibratory milling was for 72 hrs. The average diameter was about 1 μm.

The conditions for the grafting process were as follows:

Factors: (1.) Solvent System (O₂ Plasma treatment: 1 minute, and moderate reflux condition): Benzene, Acetone, Isopropyl alcohol, Benzene/Acetone=50/50, Benzene/Acetone=75/25, or Benzene/Acetone=87.5/12.5. (2.) O₂ Plasma Treatment Time (solvent: benzene, and moderate reflux condition): zero minutes, 0.5 minute, 1 minute, and 3 minutes. (3.) Reflux condition (solvent: benzene. O₂ plasma treatment: 1 minute): Moderate reflux, with a hot plate temperature=110˜120° C.; or vigorous reflux, with a hot plate temperature=140˜150° C.

Reaction procedure: The graphite samples were first treated with O₂ plasma. (RF 50%); the sample was then dispersed in a 1M-Acrylamide solution and refluxed for 5 hours; and the sample was filtered and washed with acetone, then dried in a vacuum oven.

TABLE 1
Solvent System

| Solvent | Acrylamide |
|---|---|
| Benzene | 15.37 wt % |
| Acetone | 6.39 wt % |
| Isopropyl Alcohol | 2.16 wt % |
| Benzene/Acetone = 50/50 | 21.84 wt % |
| Benzene/Acetone = 75/25 | 18.95 wt % |
| Benzene/Acetone = 87.5/12.5 | 17.75 wt % |

TABLE 2
O2 Plasma Treatment Time

| Plasma Treatment Time | Acrylamide |
|---|---|
| 0 min | 2.91 wt % |
| 0.5 min | 9.73 wt % |
| 1 min | 15.37 wt % |
| 3 min | 11.53 wt % |

TABLE 3
Reflux Condition

| Reflux Condition | Acrylamide |
|---|---|
| Moderate Reflux | 15.37 wt % |
| Vigorous Reflux | 38.25 wt % |

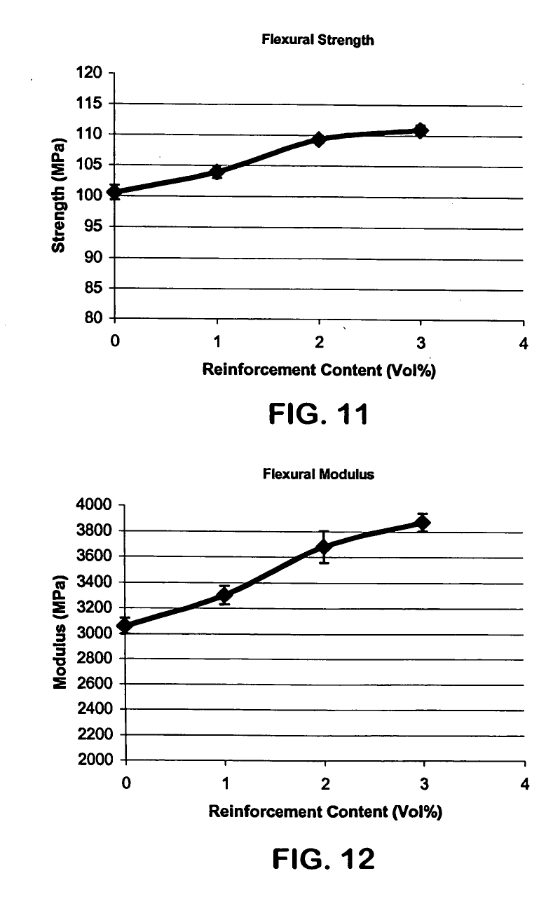

The mechanical properties of composites of acrylamide grafted graphite are shown in FIGS. 11 and 12 for a graphite sample with 38.25 wt % acrylamide.

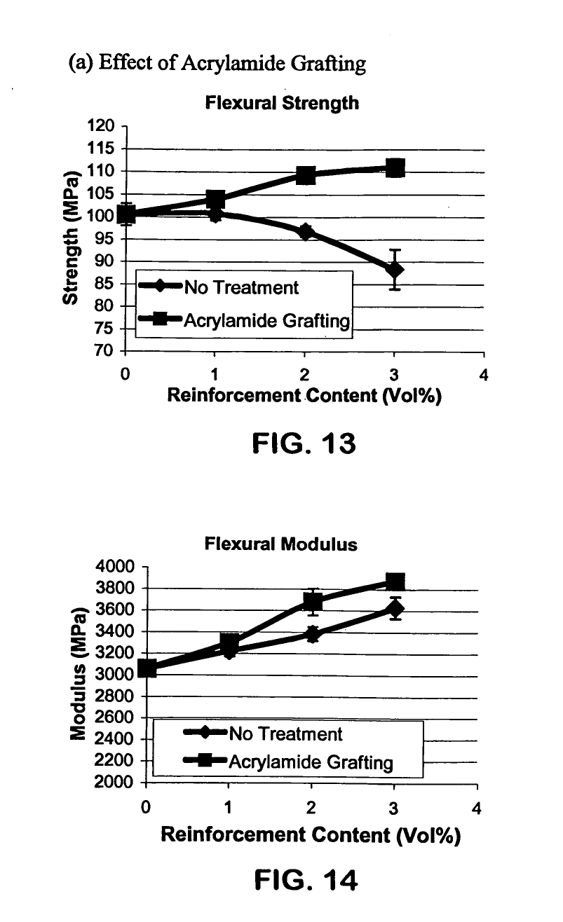

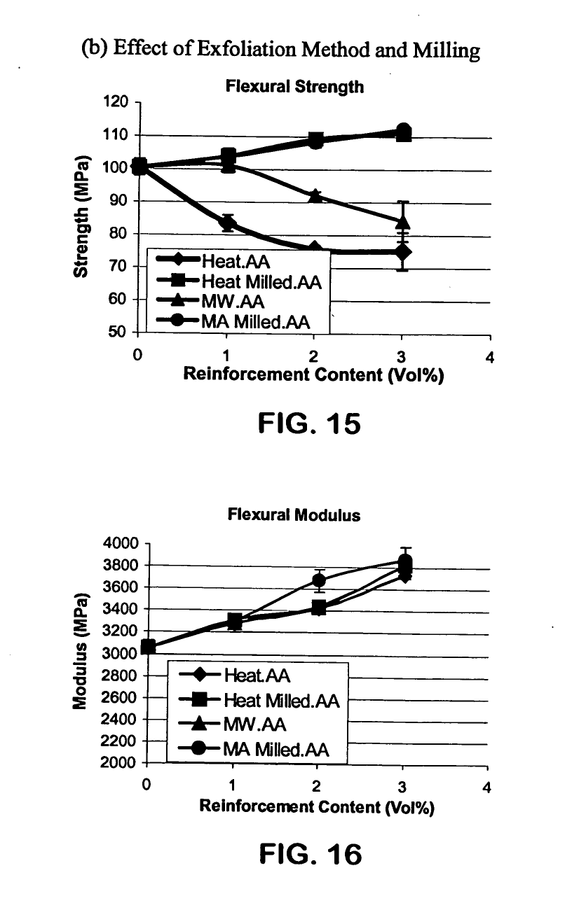

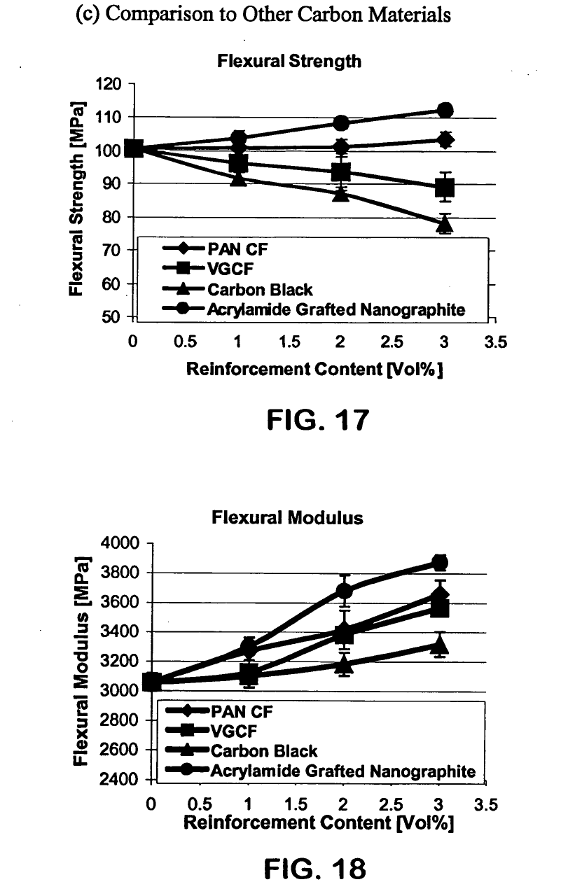

The effect of acrylamide grafting in forming composites with the epoxy resin of Example 3 is shown in FIGS. 13 to 18.

### EXAMPLE 5

Composites reinforced with nanoscopic graphite platelets were fabricated and their properties were investigated as a practical alternative to carbon nanotubes. The x-ray Diffraction (XRD) and Transmission Electron Microscopy (TEM) results indicated that the graphite flakes were well-exfoliated to achieve platelets with thicknesses of one to thirty nanometers (1-30 nm) or less. Flexural tests and Differential Mechanical Thermal Analysis (DMTA) results show that nanocomposite materials made with these nanographite platelets have higher modulus than that of composites made with commercially available carbon reinforcing materials (i.e., PAN based carbon fiber, Vapor Grown Carbon Fiber [VGCF], and Nanoscopic High-structure Carbon Black). With the proper surface treatment, the graphite nanoplatelets in polymeric matrices also showed better flexural strength than composites with other carbon materials. Impedance measurements have shown that the exfoliated graphite plates percolate at below three (3) volume percent, which is better than carbon fiber and comparable with other carbon materials, and exhibit an approximately ten (˜10) order of magnitude reduction in impedance at these concentrations.

In this Example, a microwave or radiofrequency treatment was applied to the graphite flakes to produce exfoliated graphite reinforcements. The composite material was fabricated by combining the exfoliated graphite flakes with an amine-epoxy resin. X-ray Diffraction (XRD) and Transmission Electron Microscopy (TEM) were used to assess the degree of exfoliation of the graphite platelets. The mechanical properties of this composite were investigated by flexural testing. The glass transition temperature (Tg) of composite samples was determined by Differential Mechanical Thermal Analysis (DMTA). The coefficient of thermal expansion was examined by Thermal Mechanical Analysis (TMA). The electrical conductivity was investigated by impedance measurements using the 2-probe method.

Experimental

Materials:

Epoxy was used as the matrix material. Diglycidyl ether of bisphenol A (Epon 828) was purchased from the Shell Chemical Co. Jeffamine T403 from Huntsman Petrochemical was used as the curing agent for this matrix system.

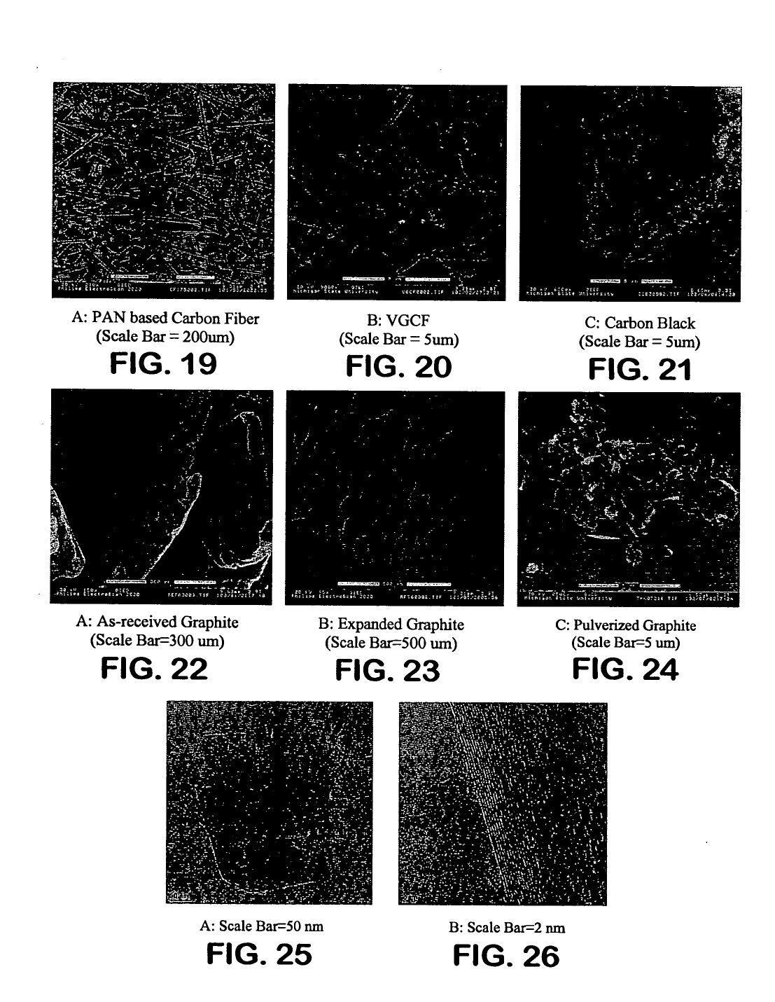

Graphite was obtained from UCAR International Inc. and were intercalated by acids. PAN based carbon fiber (PANEX 33 MC Milled Carbon Fibers, average length: 175 μm, average diameter: 7.2 μm, specific gravity: 1.81 g/cm³, Zoltek Co.), VGCF (Pyrograf III, PR-19 PS grade, Length: 50˜100 μm, Average diameter: 150 nm, Specific gravity: 2.0 g.cm³, Pyrograf Products, Inc.), and nanosize carbon black (KETJENBLACK EC-600 JD, Average diameter: 400˜500 nm, Specific gravity: 1.8 g/cm³, Akzo Novel Polymer Chemicals LLC) were used as comparison. The SEM images of these materials are shown in FIGS. 19, 20 and 21.

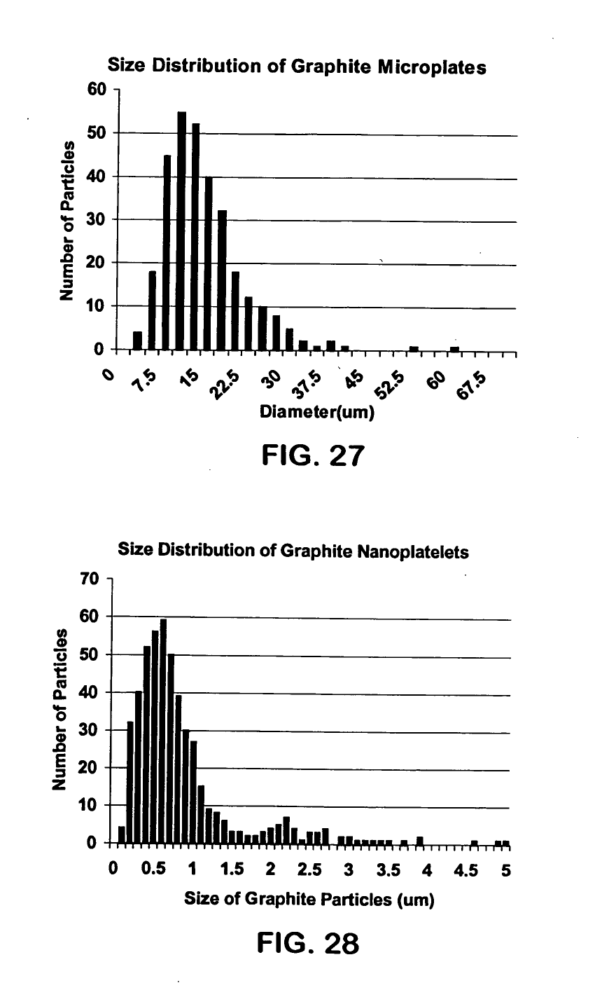

The UCAR graphite was processed with MW or RF energy. After the treatment, these graphite flakes showed significant expansion due to the vaporization of intercalated acid in the graphite galleries. The expanded graphite flakes were pulverized by use of an ultrasonic processor and mechanical milling. The average diameter and thickness of the flakes pulverized only by ultrasonic processor were determined as 15 μm and 1-30 nm, respectively (Graphite microplate). Those of the flakes after milling were determined as 0.8 μm and 1-30 nm, respectively (Graphite nanoplatelet). The SEM and TEM images of as-received, expanded, and pulverized graphite flakes are shown in FIGS. 22 to 25. The size distribution of the graphite microplate and nanoplatelets is shown in FIGS. 27 and 28.

Composite Fabrication:

The calculated amount of reinforcements were added to DGEBA and mixed with the aid of an ultrasonic homogenizer for 5 minutes. Then stoichiometric amount of Jeffamine T403 were added and mixed at room temperature. The ratio of DGEBA/Jeffamine is 100/45 by weight. The system was outgassed to reduce the voids and cured at 85° C. for 2 hours, followed by post curing at 150° C. for 2 hours. The density of graphite flakes was assumed as 2.0 g/cm³. The densities of other carbon materials were obtained from manufactures. The density of the epoxy matrix was measured as 1.159 g/cm³. Using these values, the volume fraction of graphite platelets in composite samples was calculated.

Surface Treatments of Graphite Nanoplatelets:

Surface treatments that can introduce carboxyl and/or amine group were applied to the graphite according to the following procedures.

Nitric Acid Treatment:

A graphite nanoplatelet sample was dispersed in 69% (weight) of nitric acid and heated at 115° C. for 2 hours. The sample was then washed by distilled water and dried in a vacuum oven.

O₂ Plasma Treatment:

Graphite nanoplatelets were dispersed on an aluminum foil and covered by a stainless steel mesh. Then the sample was treated by O2 plasma at RF level of 50% (275W) for 1 min.

UV/Ozone Treatment:

Graphite nanoplatelets were packed in a quartz tube (ID: 22 mm, OD: 25 mm, Transparent to UV light down to wave length of 150 nm). The tube was filled with ozone (Concentration: 2000 ppm, Flow rate: 4.7 L/min) and rotated at 3 rpm. Then the samples were exposed to UV light for 5 min.

Amine Grafting

Graphite nanoplatelets were treated by O₂ plasma to introduce carboxyl group. Then the sample was dispersed in tetraethylenepentamine (TEPA) and heated at 190° C. for 5 hours to graft TEPA by forming an amide linkage. The sample was washed with distilled water and methanol, then dried in a vacuum oven (Pattman, Jr., et al., Carbon, Vol. 35, No. 3, pp. 217 (1997)).

Acrylamide Grafting

Graphite nanoplatelets were treated by O₂ plasma to introduce peroxide. Then the sample was dispersed in 1M acrylamide/benzene solution and heated at 80° C. for 5 hours to initiate radical polymerization of acrylamide. The sample was washed with acetone and dried in a vacuum oven (Yamada, K., et al., J. Appl. Polym. Sci., Vol. 75, pp. 284 (2000)).

TABLE 4
XPS Data of Surface Treated Graphite
Nanoplatelets and Other Carbon Materials

| | C | O | N | S | Na | Al | Others | O/C | N/C |
|---|---|---|---|---|---|---|---|---|---|
| Graphite | 93.5 | 6.1 | 0.0 | 0.0 | 0.0 | 0.0 | 0.4 | 0.055 | 0.000 |
| Nanoplatelet | | | | | | | | | |
| HNO₃ | 92.2 | 7.5 | 0.0 | 0.0 | 0.0 | 0.0 | 0.3 | 0.075 | 0.000 |
| Treatment | | | | | | | | | |
| O₂ Plasma | 91.0 | 8.8 | 0.0 | 0.0 | 0.0 | 0.0 | 0.2 | 0.093 | 0.000 |
| Treatment | | | | | | | | | |
| UV/O₃ | 94.5 | 4.9 | 0.0 | 0.0 | 0.0 | 0.0 | 0.5 | 0.042 | 0.000 |
| Treatment | | | | | | | | | |
| Amine | 89.2 | 6.8 | 3.3 | 0.0 | 0.0 | 0.0 | 0.7 | 0.061 | 0.037 |
| Grafted | | | | | | | | | |
| Acrylamide | 78.3 | 14.0 | 7.8 | 0.0 | 0.0 | 0.0 | 0.0 | 0.177 | 0.100 |
| Grafted | | | | | | | | | |
| PAN based CF | 88.9 | 9.3 | 1.6 | 0.0 | 0.3 | 0.0 | 0.0 | 0.105 | 0.018 |
| VGCF | 95.1 | 4.9 | 0.0 | 0.0 | 0.0 | 0.0 | 0.0 | 0.052 | 0.000 |
| Nanosized | 91.7 | 8.2 | 0.0 | 0.0 | 0.0 | 0.0 | 0.0 | 0.089 | 0.000 |
| Carbon Black | | | | | | | | | |

Results and Discussion
XPS:

The effect of surface treatments was investigated by X-ray Photoelectron Spectroscopy (XPS). The results are shown in Table 4. From this data, the acrylamide grafting treatment showed the highest O/C and N/C ratio, suggesting many acrylamide groups were introduced. The amine grafting treatment also showed an increase in N/C ratio, suggesting amine groups were introduced. O₂ plasma treatment showed an increased O/C ratio, suggesting carboxyl groups were introduced. The other two treatments didn't show impressive results.

Mechanical Properties:

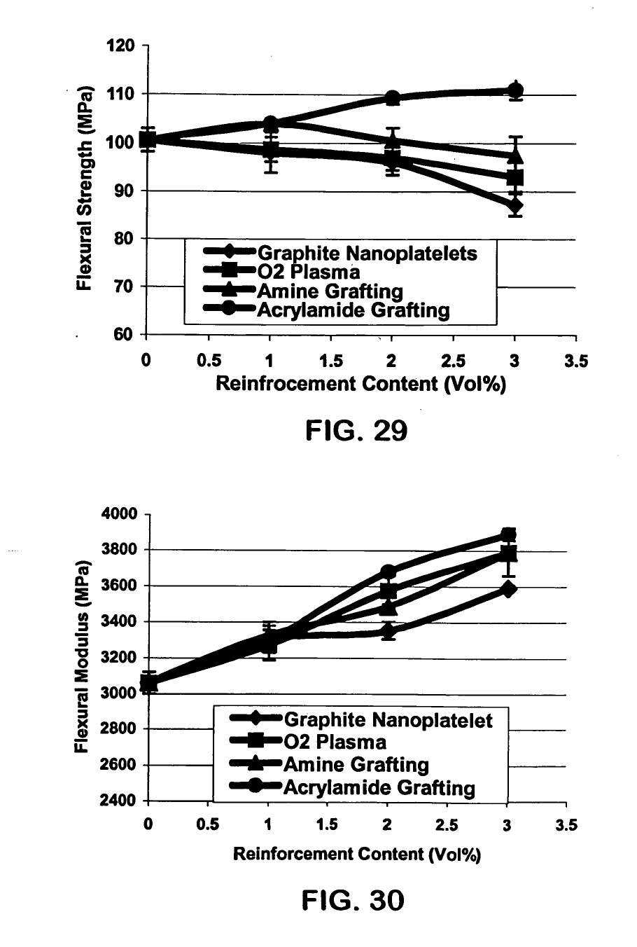

Effect of Surface Treatments on Mechanical Properties. Graphite nanoplatelets treated by O₂ plasma, amine grafting, and acrylamide grafting were prepared and used as reinforcements to fabricate composites with 1.0, 2.0 and 3.0 vol % of graphite flakes. The flexural strength and modulus of each sample are summarized in FIGS. 29 and 30.

The results indicate that the acrylamide grafting was the most effective surface treatment in terms of both strength and modulus enhancements. This is supported by XPS data that showed largest N/C ratio for acrylamide grafting. These data suggest that the amine groups grafted on graphite nanoplatelets improve the compatibility between the graphite nanoplatelets and the matrix and form a bond with the epoxy matrix and improve mechanical properties.

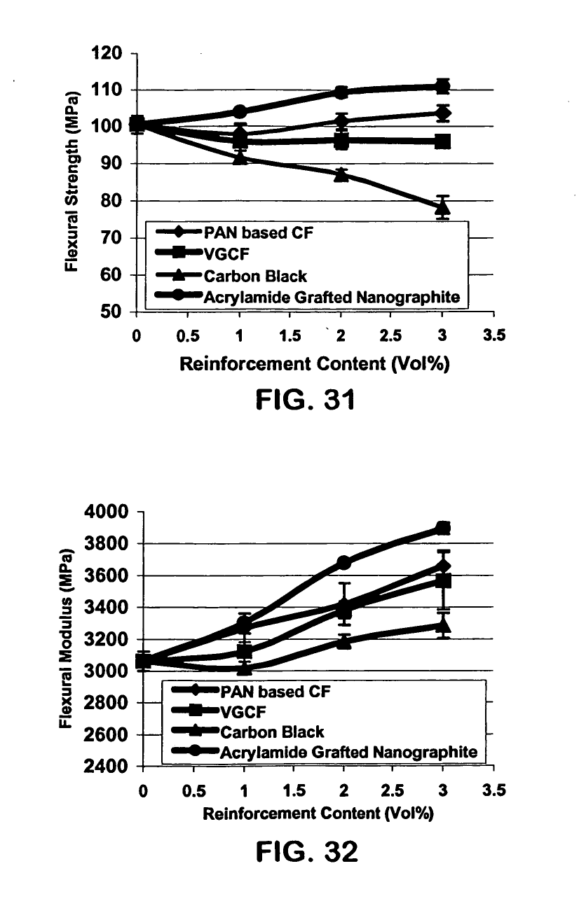

Comparison with Commercially Available Carbon Materials. Composites reinforced with PAN based carbon fibers, VGCFs, and nanosize carbon blacks were fabricated. The flexural properties of these composites were measured and compared with those of composites with acrylamide-grafted nanographite. The results are shown in FIGS. 31 and 32. Here acrylamide grafted nanographite showed the best results in terms of both strength and modulus enhancement. This implies that the acrylamide grafting treatment is a very effective surface treatment for graphite nanoplatelets.

Coefficient of Thermal Expansion:

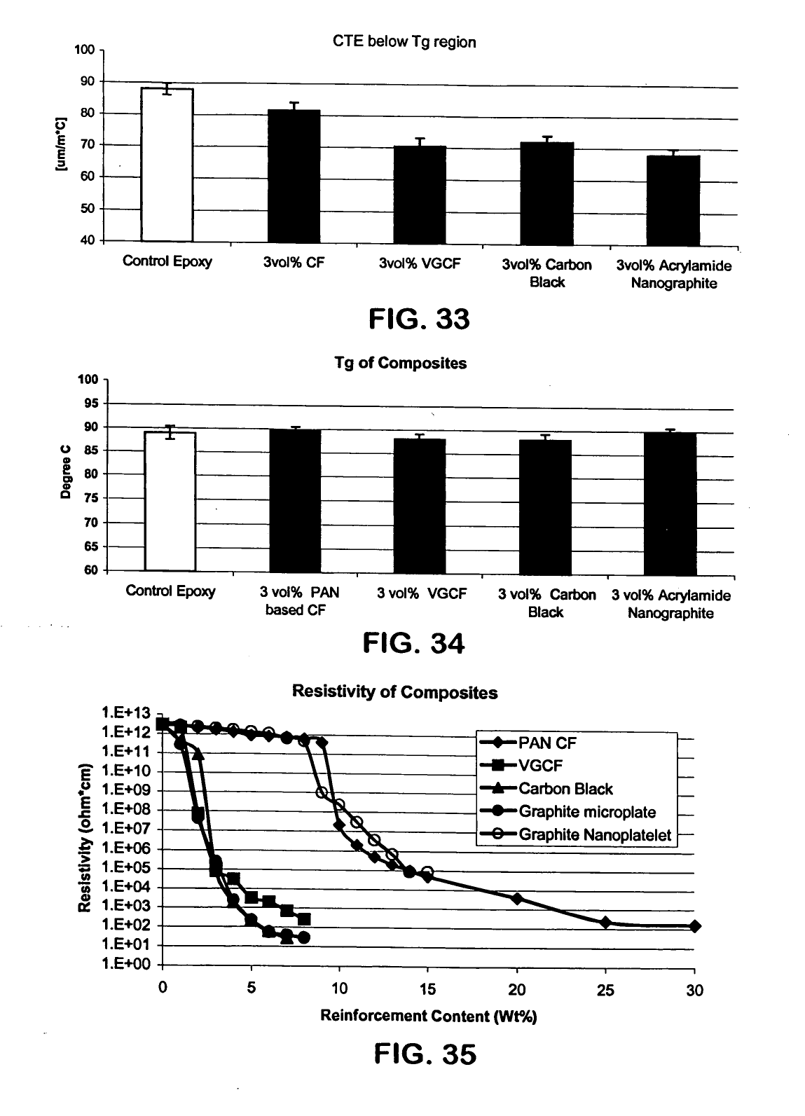

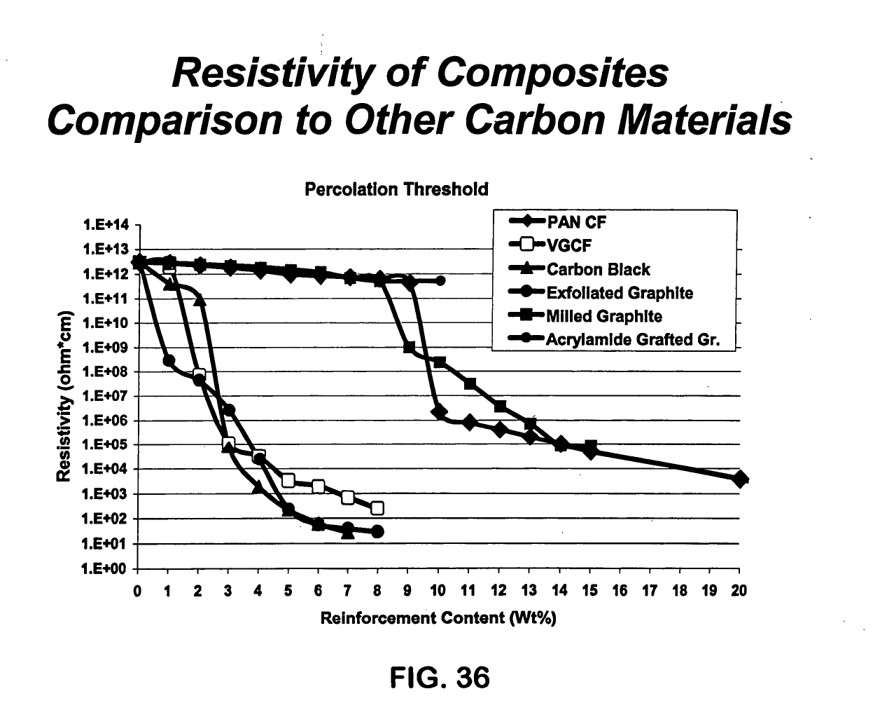

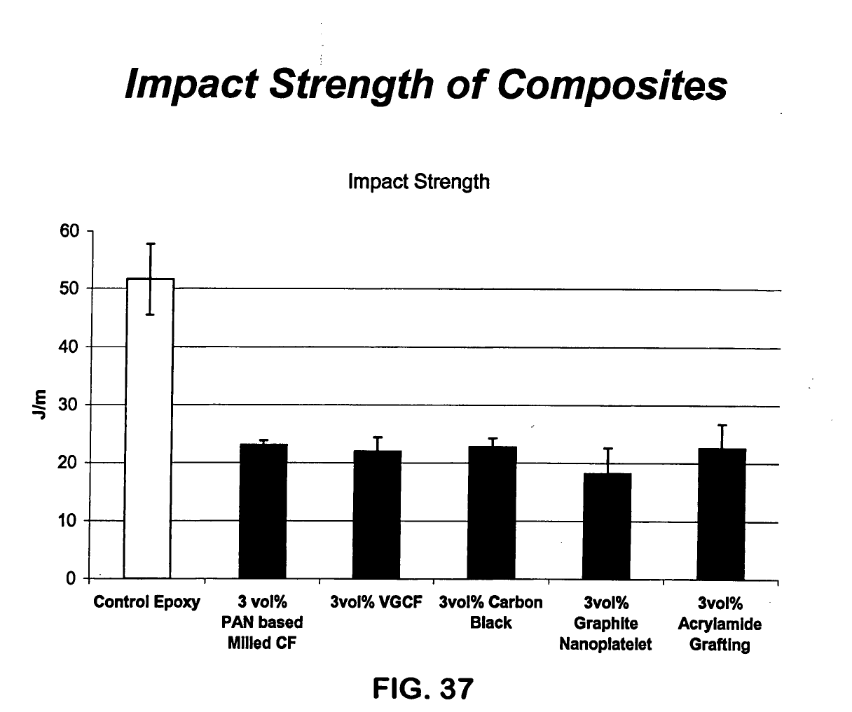

Coefficient of thermal expansion (CTE) of composites with 3 vol % of acrylamide grafted nanographite, PAN based carbon fiber, VGCF, or nanosize carbon black were determined by TMA. The results are shown in FIG. 33. The acrylamide grafted nanographite showed the lowest CTE, indicating good dispersion and strong bonding between the nanoreinforcements and the matrix. Tg:

Tg of composites with 3 vol % of acrylamide-grafted nanographite, PAN based carbon fiber, VGCF, or nanosize carbon black were determined by DMTA. The results are shown in FIG. 34. The acrylamide grafted nanographite showed the slightly higher Tg, but the difference is negligible considering the error margin of the results. Thus these reinforcements didn't affect Tg of epoxy matrix.

Electrical Property:

The electrical resistivity of the composites with various reinforcement contents were determined. The reinforcements used were PAN based carbon fiber, VGCF, nanosize carbon black, graphite microplate (exfoliated and sonicated, but not milled), and graphite nanoplatelet. The size of each composite sample was about 30×12×8 mm. Each sample was polished and gold was deposited on the surface to insure good electrical contacts. The results are summarized in FIG. 35. The VGCF, carbon black and graphite microplate percolated at around 2 wt % (1 vol %) while conventional carbon fiber and graphite nanoplatelet showed percolation threshold of about 8 to 9 wt % (5 to 6 vol %). Among the former three reinforcements, graphite microplatelets and carbon blacks produced composites with the lowest resistivity, which reached around 10^{-1.5} ohm*cm. Thus, the exfoliated graphite sample also showed excellent electrical property as reinforcement in polymer matrix.

As shown by this Example, a new nanoplatelet graphite material was developed by expansion (exfoliation) of graphite. An appropriate surface treatment was established for the new material, which produced a nanographite that increased the mechanical properties of an epoxy system better than some commercially available carbon materials at the same volume percentage. In addition, the expanded (exfoliated) graphite material has been shown to percolate at only 1 volume percent. Measurement of the impedance of this material indicates that it could be used to produce polymer matrix composites for new applications such as electrostatic dissipation and EMI shielding.

The present invention provides a fast and economical method to produce expanded graphite particles, expanded by using RF or microwave energy as the expansion method. It is especially useful in large-scale production and could be a very cost-effective method which would lead to increased use of the exfoliated graphite material.

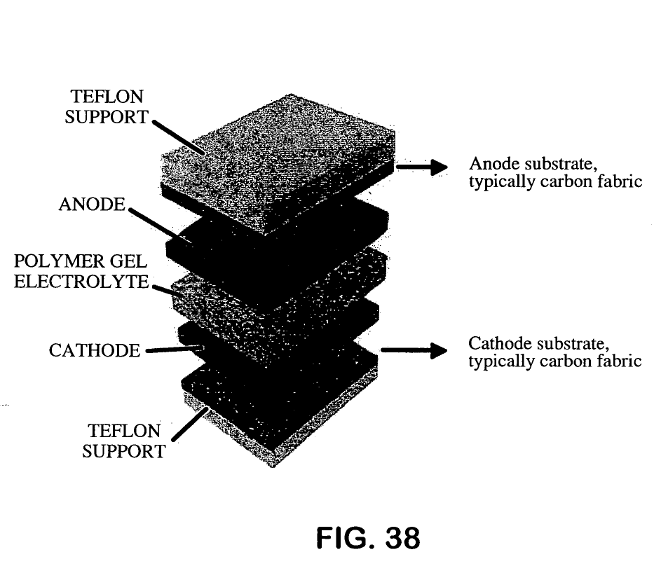

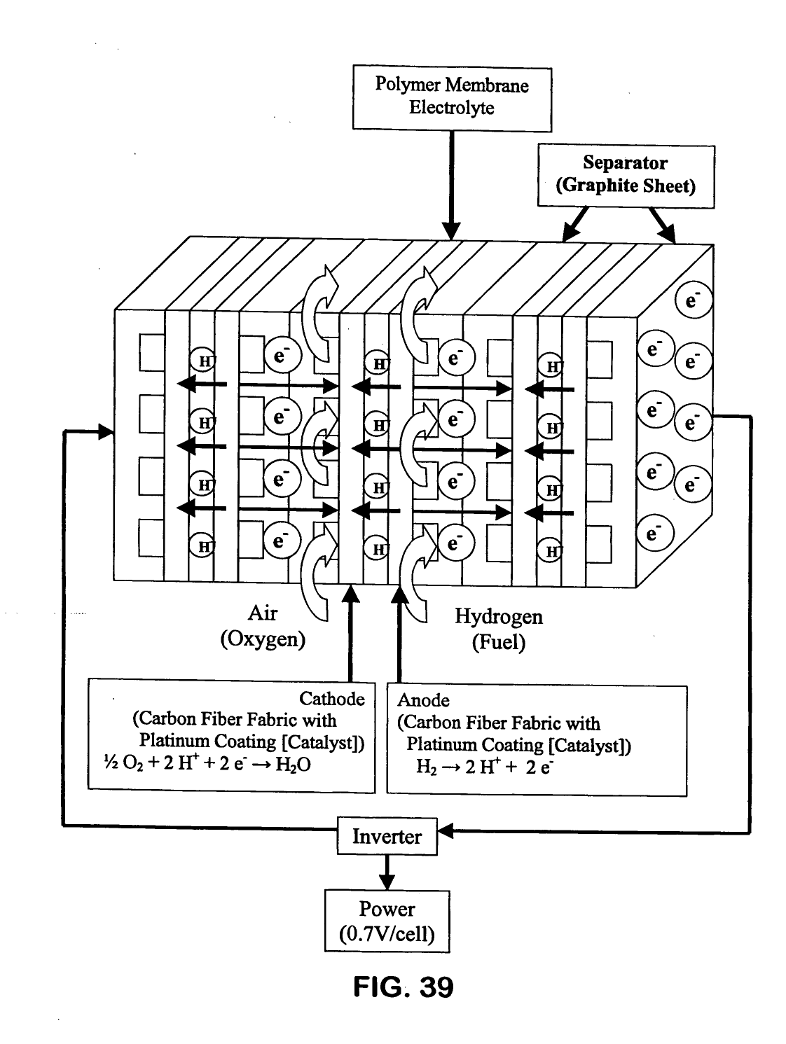

The expanded graphite can be compressed or calendared to make sheets with or without resins and/or other additives. These sheets can be used as insulating material. In furnaces or gaskets/sealing materials for internal combustion engines. Also these sheets can be used as electrodes substrates for polymer batteries (FIG. 38) or separator (or fluid flow field plates) for fuel cells (FIG. 39).

The expanded graphite can be pulverized into platelets with an appropriate grinding method. Platelets with a high aspect ratio can be used as reinforcements in composites, which have high mechanical properties as well as good electrical and thermal conductivity.

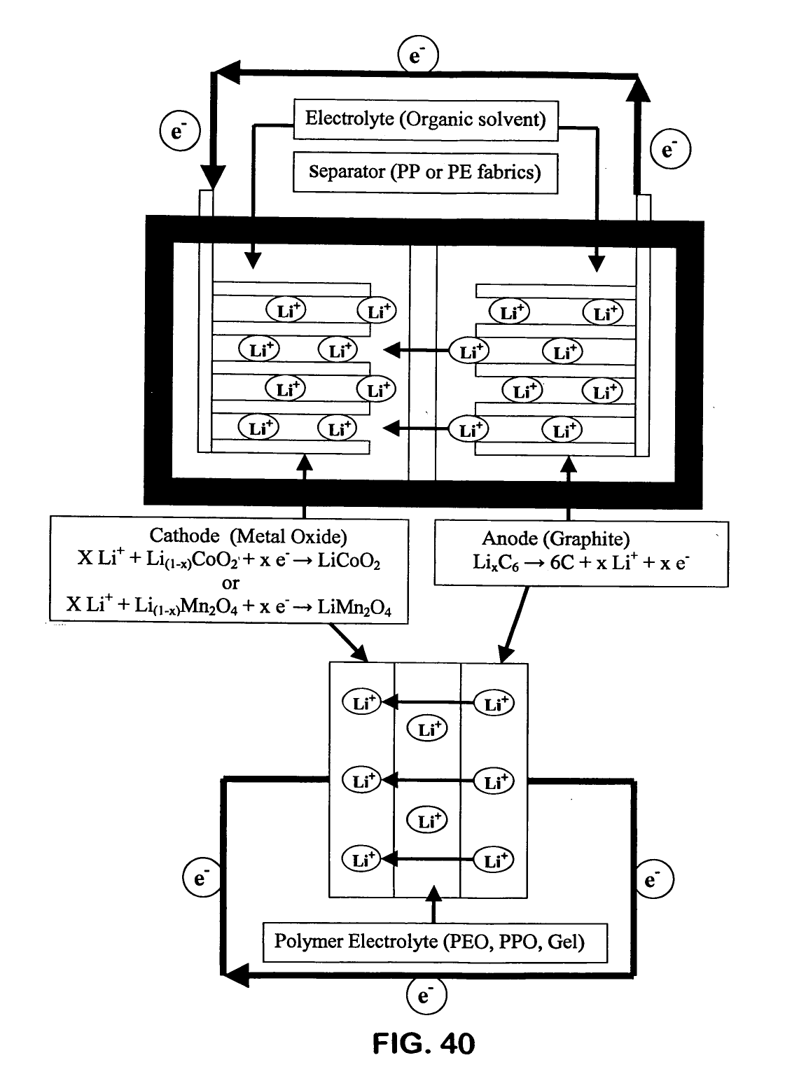

Expanded graphite with an appropriate platelet size can be used as a substrate for metal particles such as lithium, which is suitable as anode material for lithium-ion or lithium-polymer batteries (FIG. 40).

### EXAMPLE 6

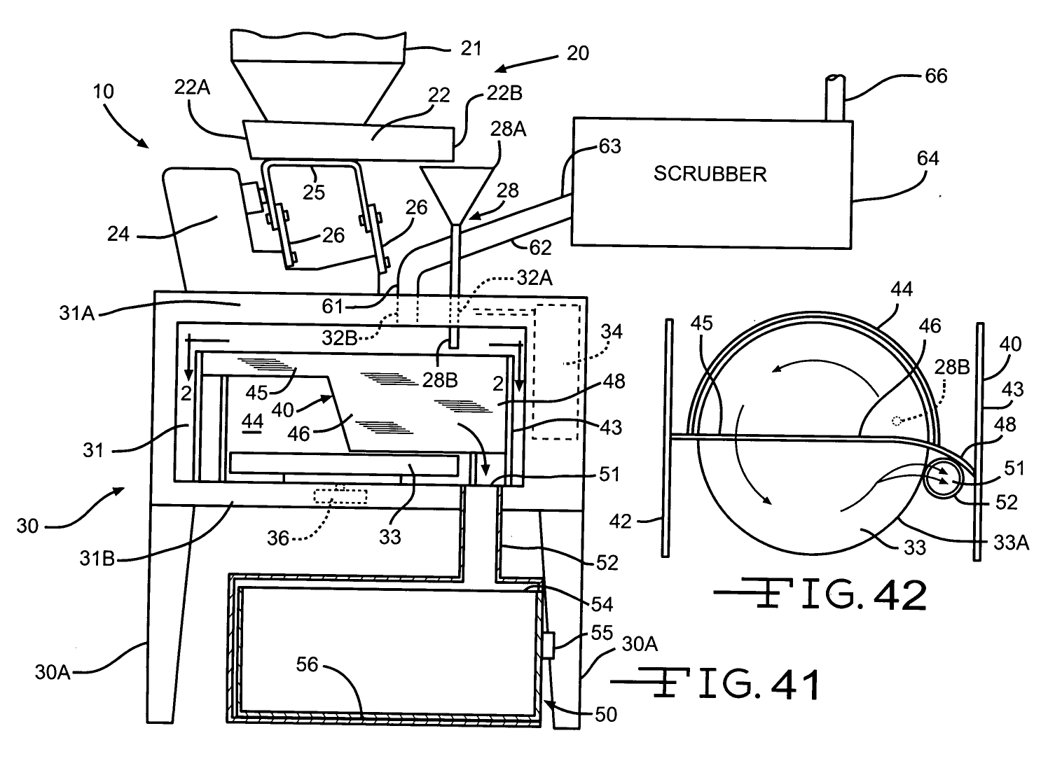

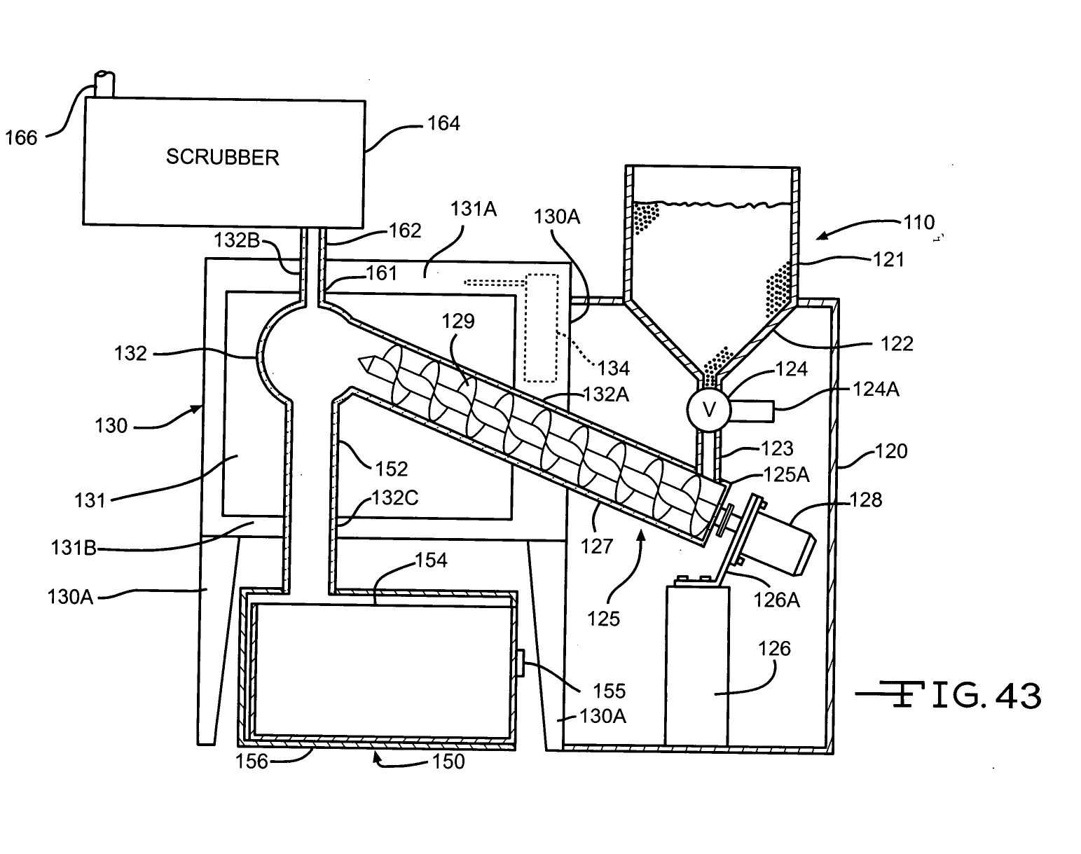

This example describes four embodiments of an apparatus for expanding unexpanded graphite in a continuous process, however other embodiments are encompassed by the present invention. The disclosed process consists of several important components (depicted in FIG. 41 to FIG. 45). Each apparatus (10, 110, 210, 310) can optionally be isolated behind a wire cage with less than 0.20 inch (5.08 mm) mesh spacing for EMF shielding. A mechanism is employed to feed intercalated graphite particles into a microwave oven cavity. A feed means such as, but not limited to a vibratory-type feeder, gravimetric or volumetric auger-type feeder, injector, flowing or dripping fluid suspension, blower, compressed gas, vacuum, gravity, conveyor belt, drum, wheel, slide, chute, or any combination of these or other means for feeding granules or powders can be used.

Once the graphite has entered the microwave processing chamber, a means for conveying the graphite through the chamber is employed. This can be accomplished by a mechanism as a conveying means such as, but not limited to a conveyor belt, rotating plate (carousel), auger (screw conveyor), gravity, aerosol cloud, dynamic air circulation, electric field, or any combination of these or other methods of powder and granular material transport. Activation and exfoliation of the graphite is accomplished by a mechanism, such as a magnetron, capable of generating of microwave radiation with an output frequency between 300 MHz and 300 GHz. (Typical domestic microwaves utilize a magnetron tube to generate microwaves at or near a frequency of 2450 MHz.)

After exfoliation, a means for removing the exfoliated graphite from the processing chamber is employed. This can be accomplished by the use of one or more passive or active removing means such as gravity, a mechanical wiper, tube, classifier, vacuum, plate, brush, wheel, slide, chute, adhesive tape, fabric, filter, compressed gas, fluid rinse, or any combination of these or other methods for capturing and transporting low bulk density materials. The means for removing the graphite can act as a sorting means that selectively removes the exfoliated graphite and allow the unexpanded graphite to recycle through the microwave chamber for one or more cycles before passing through an exit means such as a passive chute means or an active mechanism such as a conveyor. In this manner, a wiper, rotating plate carousel, and a chute acting together is one embodiment of a recycle means that sorts exfoliated graphite for removal while recycling the unexpanded graphite until it has been expanded.

The exfoliated graphite can then be collected on or in a collecting means such as a bulk container, belt, wheel, sheet, fabric, fluid suspension, paste, slurry, vacuum bag, woven and non woven fibers, mat, or any combination of these or other methods for collecting low bulk density materials. Alternately, the exfoliated graphite can be immediately conveyed directly or indirectly into other downline machines such as, but not limited to mills, presses, extruders, and mixers. The exfoliated graphite can be the end product, or it can be incorporated by additional processing into other polymeric, elastomeric, ceramic, metallic, hybrid, or other materials to produce new material formulations. The application of these constituent processes are the embodiments of the invention.

FIG. 41 is an illustration of one embodiment of a continuous carousel type microwave apparatus 10 of the present invention. The apparatus 10 expands graphite which has been intercalated with a chemical. In this embodiment intercalated graphite particles are loaded into a bin 21 at the top of the apparatus 10. The bin 21 deposits the graphite particles into a feed means such as vibratory feeder 20 mounted above the chamber 31 of a microwave applicator device 30 (illustrated with the door of the device 30 removed for viewing). The particles are deposited towards a first end 22A of a trough 22 of the feeder 20. A vibratory drive having a housing 24 advances the particles in the trough 22 by pushing against mounting bracket 25 attached to the bottom of the trough 22 at the top 25A and to the housing 24 of the drive by means of flexible bands 26. An example of a vibratory feeder 20 is Syntron® feeder model FT0-C (FMC Technologies, Houston, Tex.), however other types of feeders can be used as a feed means in conjunction with the apparatus 10. Preferably, the feed means can be adjusted to control the feed rate.

When the vibratory feeder 20 is activated, the intercalated graphite particles are advanced to a second end 22B of the feeder 22 where they drop into the mouth 28A of a funnel 28 which transports the particles into a tube 28B at an end of the funnel 28 that passes through a first opening 32A in a top wall 31A of the chamber 31 of a microwave applicator device 30. The particles then drop onto an internal rotatable plate 33 within the chamber 31 which supports the intercalated unexpanded graphite. A microwave generator 34 emits microwave energy into the chamber 31 when activated to irradiate the particles. Preferably, the energy output and duty cycle of the microwave generator can be varied. A motor 36 spins the internal rotatable plate 33 during microwave irradiation. Preferably, the motor 36 includes a speed control mechanism to adjust the rotation speed of the internal rotatable plate 33. This is one means to control the residence time of the graphite in the chamber 31. A wiper plate 40 as one embodiment of a wiper means is mounted in the chamber 31 to selectively separate the expanded graphite from the intercalated unexpanded graphite as the plate 33 rotates. Intercalant exhaust is removed from the chamber 31 by means of an exhaust tube 62, the first end 61 of which passes through a second opening 32B in a top wall 31A of the chamber 31 of a microwave applicator device 30. A second end 63 of the exhaust tube 62 enters a scrubber 64, which removes the intercalant acid fumes before releasing the scrubbed exhaust gases from a vent 66 on the scrubber 64.

The wiper plate 40 is mounted over the internal rotatable plate 33 upon a first leg 42 and a second leg 43 supporting either end of the wiper plate 40. The first leg 42 attaches to a narrow portion 45 extending to a center of the wiper plate 40. The narrow portion 45 allows unexpanded and expanded graphite to pass beneath it on the internal rotatable plate 33. A second leg 43 attaches at a wide portion 46, which extends to the narrow portion 45 at the center of the wiper plate 40. As the unexpanded graphite is irradiated and the graphite expands, it is kept from falling off of the outer edge 33A of the internal rotatable plate 33 by a holding wall 44 best seen in FIG. 42. The holding wall 44 extends around the outer edge 33A of the internal rotatable plate 33 from the wide portion 46 to the narrow portion 45. The wide portion 46 is mounted low over the internal rotatable plate 33 close enough such that expanded graphite cannot pass beneath the wiper plate 40. Since the expanded graphite cannot pass beneath the wide portion 46 of the wiper plate 40, it builds up on the internal rotatable plate 33 at a curved portion 48. The rotation of the internal rotatable plate 33 at the curved portion 48 selectively moves the expanded graphite into a chute 42 as a chute means which is adjacent to the outer edge 33A of the internal rotatable plate 33. The wiper plate 40 is shaped to drive the expanded graphite off the outer edge 33A and into a top opening 51 of a chute 52 where it passes by gravity from the chamber 31 and into a container 50. The chute 52 is one embodiment of a means for removing the expanded graphite from the chamber 31 of the microwave applicator 30, however other means of removing the expanded graphite are encompassed by the present invention. The unexpanded graphite is small enough to pass beneath the wide portion 46 of the wiper plate 40 to make another turn while exposed to the microwave energy.

The microwave applicator device 30 is optionally mounted on legs 30A, such that a container 50 can be placed beneath the device 30. The chute 52 passes through an opening in the bottom wall 31B of the chamber 31 of the microwave applicator device 30 and into a container 50 for receiving the expanded graphite from the chute 52. In some embodiments, the expanded graphite is captured in a drawer 54 in an outer housing 56 of the container 50, which can be pulled out from the outer housing 56 by means of handle 55 to remove the expanded graphite.

In the working model of this invention, the vibratory feeder 20 drops acid-intercalated graphite flakes through a tube 28B into a microwave applicator device 30 such as a modified conventional 2.45 GHz microwave oven with sufficient safeguards to prevent leakage of the microwave radiation. The graphite falls onto the internal rotatable plate 33 within the chamber 31 located in the oven. Microwave radiation rapidly heats both the intercalant acid and the conductive graphite causing the acid to vaporize giving rise to a substantial pressure within the graphite material. The pressure exceeds the cohesive strength of the graphite particle and causes preferential separation of the graphene sheets. This results in a very large, rapid increase in the bulk volume of the graphite, which takes on a fluffy, ash-like texture and form. As the internal rotatable plate 33 rotates, the exfoliated graphite is brought into contact with the static wiper plate 40 that guides the graphite off the outer edge 33A of the rotatable plate 33 as it rotates and into the vertical chute 52 leading to a collection container 50 located under the oven. Graphite flakes that have not been sufficiently heated to cause exfoliation pass under the wiper plate 40 and continue to be exposed to microwave radiation, until their eventual exfoliation. At the conclusion of this process, the exfoliated graphite is recovered from the collection container 50.

This working model of the disclosed process has yielded graphite at a rate of 6 grams per minute; equivalent to a rate of about 350 grams per hour. Prior to the development of the disclosed method, a batch process has been employed to produce exfoliated graphite at a yield rate between 5 and 10 grams per hour. Implementation of this invention has thus resulted in a fifty fold increase in the processing yield rate of exfoliated nano-graphite platelets. Further scale-up is possible using the concepts developed to rates which are industrially attractive. Ongoing research will result in greater enhancement in graphite platelet exfoliation productivity. The working prototype has been constructed using a modified commercial kitchen microwave oven as illustrated in FIG. 41 and FIG. 42. This prototype is in operation.

FIG. 43 is an illustration of one embodiment of a continuous screw conveyor type microwave apparatus 110 of the present invention. In this embodiment intercalated graphite particles are loaded into a bin 121 at the top of the apparatus 110. The bin 121 has a lower funnel portion 122 which funnels the intercalated graphite particles through a housing 120 and into a tube portion 123 at an end of the funnel portion 122. The tube portion 123 has a valve 124 driven by an actuator 124A to control the release of the intercalated graphite particles into a first end 125A of a screw conveyor 125. The screw conveyor 125 has an outer cylindrical wall 127 having an internal screw 129 (auger) which is driven by a variable speed motor 128. The variable speed motor 128 and screw conveyor 125 are mounted by means of bracket 126A to a pedestal 126 mounted in housing 120. The internal screw 129 and outer cylindrical wall are constructed of ceramic, Teflon® polymer, or other lossless material. The cylindrical wall 127 of the screw conveyor 126 passes through a first opening 132A in a side wall 130A defining a chamber 131 of a microwave applicator device 130 (illustrated with the door of the device 130 removed for viewing). The particles are driven into the chamber 131 by the internal screw 129 where they drop into an internal expansion chamber 132 within the chamber 131.

The intercalated unexpanded graphite are irradiated in the expansion chamber 132 to expand the graphite. The internal expansion chamber 132 is constructed of ceramic, Teflon® polymer, or other lossless material that microwaves will penetrate. A microwave generator 134 emits microwave energy into the chamber 131 when activated to irradiate the particles. Preferably, the energy output and duty cycle of the microwave generator can be adjusted. The variable speed motor 128 spins the internal screw 129 to continuously provide the intercalated graphite particles during microwave irradiation. Intercalant acid vapors are removed from the chamber 131 at a first end 161 of an exhaust tube 162 which passes through a second opening 132B in a top wall 131A of the chamber 131 of the microwave applicator device 130. The exhaust tube 162 enters a scrubber 164, which removes the intercalant acid fumes before releasing scrubbed gases from a vent 166 on the scrubber 164.

The microwave applicator device 130 is optionally mounted on legs 130A, such that a container 150 can be placed beneath the device 130. The expanded graphite falls into through a chute 152 where it passes by gravity from the chamber 131 and into a container 150. The chute 152 passes through a third opening 132C in a bottom wall 131B of the chamber 131 of a microwave applicator device 130 and into a container 150 for receiving the expanded graphite from the chute 152. In some embodiments, the expanded graphite is captured in a drawer 154 in an outer housing 156 of the container 150, which can be pulled out from the outer housing 156 by means of handle 155 to remove the expanded graphite.

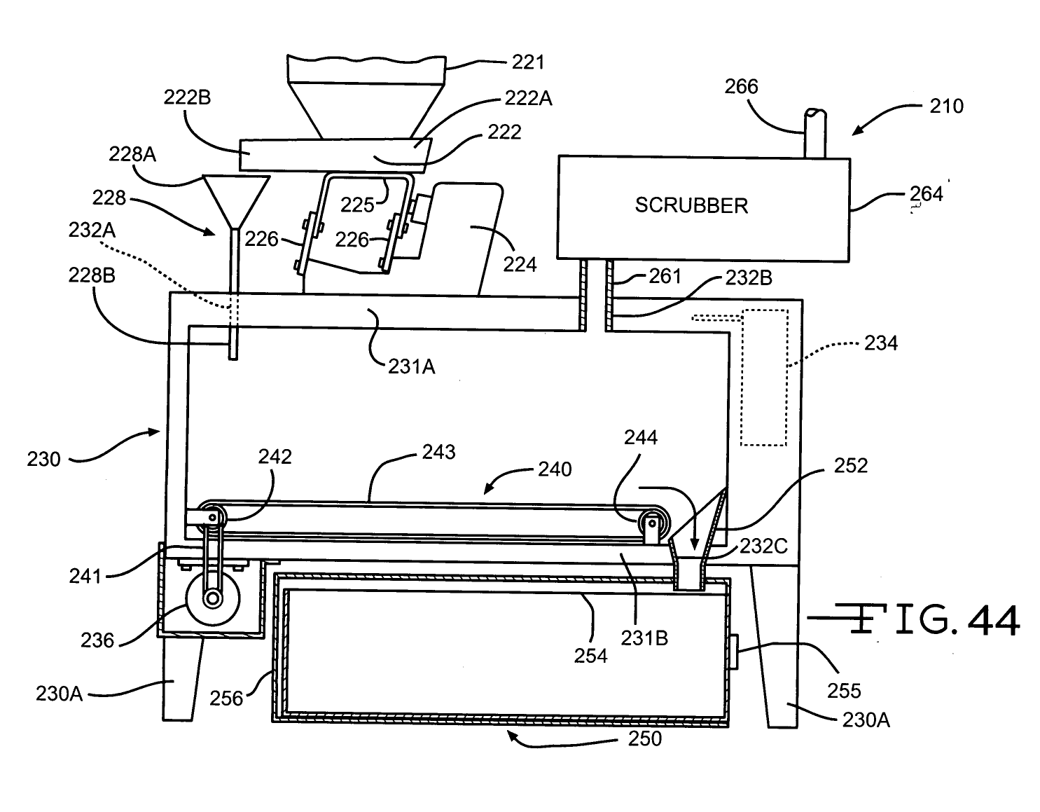

FIG. 44 is an illustration of one embodiment of a continuous belt conveyor type microwave apparatus 210 of the present invention. In this embodiment intercalated graphite particles are loaded into a bin 221 at the top of the apparatus 210. The bin 221 deposits the graphite particles into a feed means such as vibratory feeder 220 mounted above the chamber 231 of a microwave applicator device 230 (illustrated with the door of the device 230 removed for viewing), The particles are deposited towards a first end 222A of a trough 222 of the feeder 220. A vibratory drive having a housing 224 advances the particles in the trough 222 by pushing against mounting bracket 225 attached to the bottom of the trough 222 at the top 225A and to the housing 224 of the drive by means of flexible bands 226. An example of a feeder 220 is Syntron® feeder model FT0-C (FMC Technologies, Houston, Tex.), however other types of feeders can be used as a feed means in conjunction with the apparatus 210.

The intercalated graphite particles are advanced to a second end 222B of the feeder 222 where they drop into the mouth 228A of a funnel 228 which transports the particles into a tube 228B at an end of the funnel 228 which passes through a first opening 232A in a top wall 231A defining the chamber 231 of a microwave applicator device 230. The particles then drop onto an internal belt conveyor 240 within the chamber 231 which supports the intercalated unexpanded graphite. The internal belt conveyor 240 has a conveyor belt 243 which passes around a first wheel 242 mounted to one end of the chamber 231 and a second wheel 244 mounted to a second end of the chamber 231. A variable speed motor 236 advances the internal belt conveyor 233 during microwave irradiation by means of a drive belt 241 which rotates the first wheel 242. The motor 236 can include a speed control mechanism (not shown) to adjust the speed of the belt conveyor 233 and thus the residence time of the graphite particles in the chamber 231. A microwave generator 234 emits microwave energy into the chamber 231 when activated to irradiate the particles. Preferably, the energy output and duty cycle of the microwave generator 234 can be adjusted. Intercalant acid fumes generated during irradiation are removed from the chamber 231 by means of an exhaust tube 261 which passes through a second opening 232B in a top wall 231A defining the chamber 231 of the microwave applicator device 230. The exhaust tube 261 enters a scrubber 264, which removes the intercalant acid fumes before releasing the scrubbed gases from a vent 266 on the scrubber 264.

The microwave applicator device 230 is optionally mounted on legs 230A, such that a container 250 can be placed beneath the device 230. The advancement of the internal belt conveyor 240 moves the expanded graphite into a chute 252 which is at the second end of the chamber 231. The internal belt conveyor 240 drops the expanded graphite into a top opening of a chute 252 where it passes by gravity from the chamber 231 and into a container 250. The chute 252 passes through an opening 232C in a bottom wall 231B of the chamber 231 of a microwave applicator device 230 and into a container 250 for receiving the expanded graphite from the chute 252. In some embodiments, the expanded graphite is captured in a drawer 254 in an outer housing 256 of the container 250, which can be pulled out from the outer housing 256 by means of handle 255 to remove the expanded graphite.

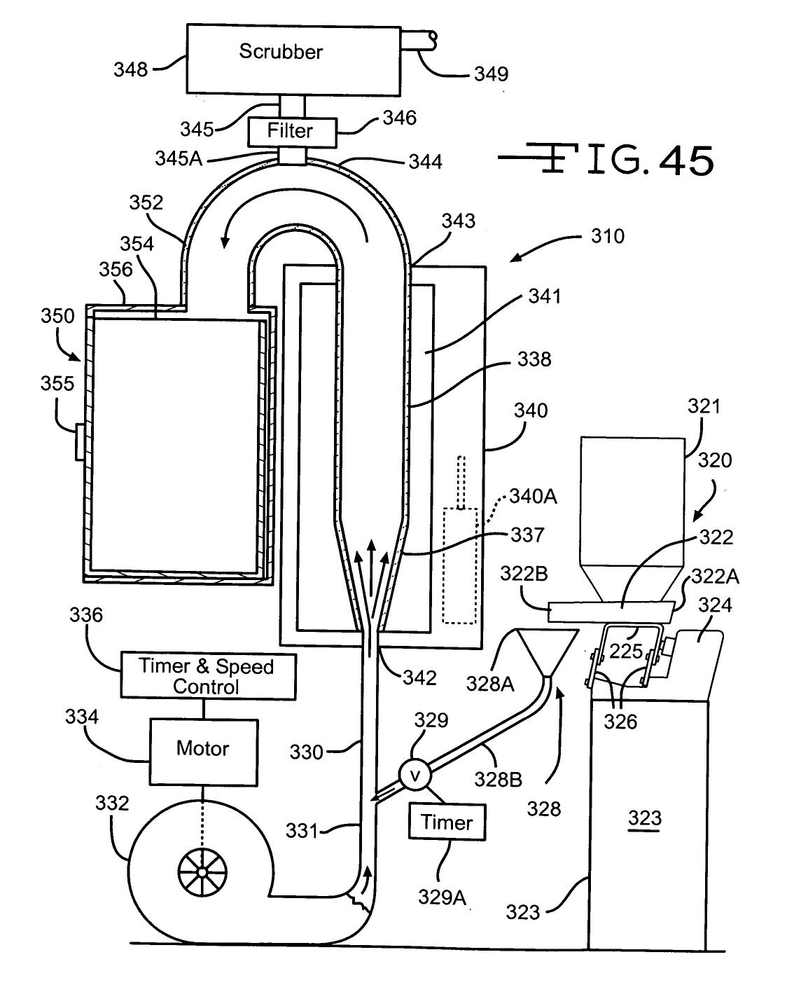

FIG. 45 is an illustration of one embodiment of a continuous blower type microwave apparatus 310 of the present invention. In this embodiment intercalated graphite particles are loaded into a bin 321 on the apparatus 310. The bin 321 deposits the graphite particles into a feed means such as vibratory feeder 320 mounted on a pedestal 323 or other stable support. The particles are deposited towards a first end 322A of a trough 322 of the feeder 320. A vibratory drive having a housing 324 advances the particles in the trough 322 by pushing against mounting bracket 325 attached to the bottom of the trough 322 at the top and to the housing 324 of the drive by means of flexible bands 326. An example of a feeder 320 is Syntron® feeder model FT0-C (FMC Technologies, Houston, Tex.), however other types of feeders can be used as a feed means in conjunction with the apparatus 310.

The intercalated graphite particles are advanced to a second end 322B of the feeder 322 where they drop into the mouth 328A of a funnel 328 which transports the particles into a tube 328B at an end of the funnel 328 which passes through a valve 329 driven by an actuator 329A to control the release of the intercalated graphite particles into a narrow portion 331 of blower pipe 330. The valve 329 can be used to control the feed rate into the blower pipe 330.

A motor 334 controlled by an adjustable timer and speed controller 336 drives a blower 332 which blows the intercalated graphite particles upwards through the narrow portion 331 of blower pipe 330 and into a microwave device 340. The narrow portion 331 of blower pipe 330 enters the chamber 331 through a first hole 342 in a bottom side of the microwave device 340 (illustrated with the door of the device 340 removed for viewing). The blower pipe 330 increases in diameter at a flare portion 337 inside the chamber 341 of the microwave device 340. The flare portion 337 extends into a wide portion 338 that passes through the chamber 341 and out of a top hole 343 in a top of the microwave device 340. The flare portion 337 and wide portion 338 are constructed of ceramic, Teflon® polymer, or other lossless material which allows the microwave energy to penetrate and heat the graphite within. A microwave generator 340A emits microwave energy when activated to irradiate the intercalated graphite particles in the chamber 341. Since the timer and speed controller 336 can adjust the speed of the blower 332 the residence time of the graphite particles in the chamber 341 can be adjusted.

The wide portion of the blower pipe 330 extends from the microwave device 340, where it bends back downwards in a curved portion 344. Acid vapors are removed from the chamber 341 by means of an exhaust tube 345 which vents the curved portion 344 at the top of the blower pipe 330. The exhaust tube 345 has a filter 346 near a first end 345A to keep solids from entering a scrubber 348 connected to the exhaust tube 345. The scrubber 348 removes the intercalant acid fumes before releasing the scrubbed gases from a vent 349 exiting the scrubber 349. At a distal end of the curved portion 344 is a chute portion 352 that empties into a container 350. The expanded graphite moves through the curved portion 344 and into a chute portion 352 where it passes into the container 350 for receiving the expanded graphite from the chute portion 352. In some embodiments, the expanded graphite is captured in a drawer 354 in an outer housing 356 of the container 350, which can be pulled out from the outer housing 356 by means of handle 355 to remove the expanded graphite.

FIG. 46 is an illustration of a simplest embodiment of the method of expanding intercalated graphite in batch mode within a microwave apparatus 410 while in a gaseous atmosphere. The unexpanded intercalated graphite particles are placed into a beaker 415 and inserted into the chamber 431 of a microwave oven as the microwave applicator device 430 of the apparatus 410 (illustrated with the door e of the device 30 removed for viewing). A microwave generator 434 emits microwave energy into the chamber 431 when activated to irradiate the particles. Preferably, the energy output and duty cycle of the microwave generator can be varied. Intercalant exhaust is removed from the chamber 431 by means of an exhaust tube 462, the first end 461 of which passes through an opening 432 in a top wall 431A of the chamber 431 of a microwave applicator device 430. A second end 463 of the exhaust tube 462 enters a scrubber 464, which removes the intercalant acid fumes before releasing the scrubbed exhaust gases from a vent 466 on the scrubber 464. In this embodiment, the graphite particles are expanded in a gaseous atmosphere 470 such as air, however other gases can be used. Various gaseous atmospheres can be used, such as argon or other noble gases. The gaseous atmosphere 470 does not have to be inert, however, since even air having oxygen can be used safely as the gaseous atmosphere.

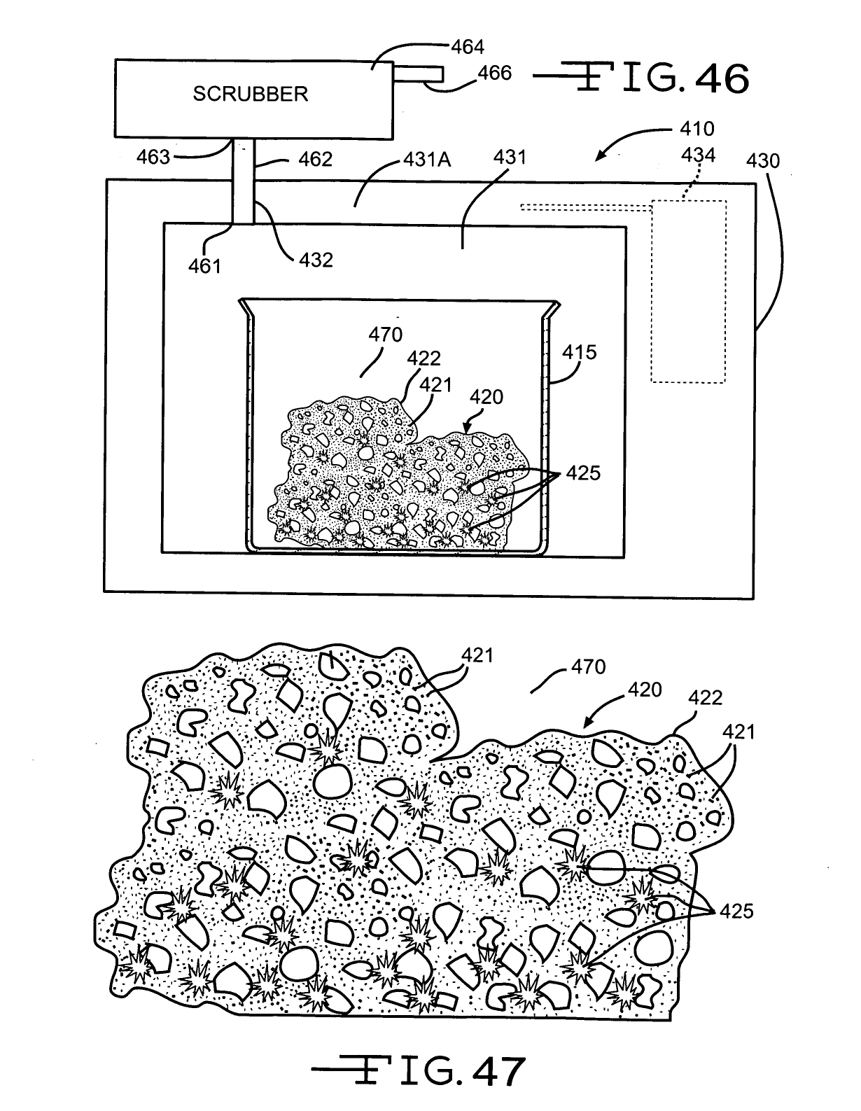

It is unexpected that air having oxygen can be used as the gaseous atmosphere 470 in the present invention, since the exfoliation process in the microwave apparatus causes the graphite particles to emit intense sparks 425. FIG. 47 is an illustration of the expanding graphite 420 in a gaseous atmosphere 470. As illustrated, when the unexpanded graphite 421 expands to form expanded graphite 422, intense sparks 425 are emitted into the gaseous atmosphere 470. The lossy graphite material absorbs the microwave energy and rapidly heats to extremely high temperatures. During this process the graphite particles emit intensely bright sparks 425. Unexpectantly, the sparks 425 do not cause damage while in the presence of oxygen in the gaseous atmosphere 470.

While the present invention is described herein with reference to illustrated embodiments, it should be understood that the invention is not limited hereto. Those having ordinary skill in the art and access to the teachings herein will recognize additional modifications and embodiments within the scope thereof. Therefore, the present invention is limited only by the Claims attached herein.

We claim:

1. An apparatus for expanding unexpanded intercalated graphite in the presence of a gaseous atmosphere with a chemical which expands upon heating to produce expanded graphite which comprises:
(a) a microwave or radiofrequency applicator with a chamber for expanding the intercalated unexpanded graphite;
(b) feed means for feeding the intercalated unexpanded graphite into the chamber;
(c) sorting means in the chamber for differentiating between the expanded graphite and the intercalated unexpanded graphite;
(d) exit means from the chamber for receiving the expanded graphite from the sorting means with exclusion of the intercalated unexpanded graphite; and
(e) optionally a recycling means for retreating the intercalated unexpanded graphite in the chamber of the applicator.

2. The apparatus of claim 1 which provides continuous feed and expansion of the intercalated unexpanded graphite between the feed opening means and the exit means.

3. The apparatus of claim 1 wherein the recycling means further comprises a speed control which can adjust the residence time of the graphite in the chamber of the microwave or radiofrequency applicator.

4. The apparatus of claim 1 wherein the feed means comprises a vibratory-type feeder, gravimetric feeder, volumetric auger-type feeder, injector, flowing fluid suspension, dripping fluid suspension, blower, compressed gas feeder, vacuum feeder, gravity feeder, conveyor belt feeder, drum feeder, wheel feeder, slide, chute, or combination thereof.

5. The apparatus of claim 1 wherein the sorting means sorts the expanded graphite from the expanded intercalated graphite based upon a size difference.

6. An apparatus for expanding unexpanded intercalated graphite in the presence of a gaseous atmosphere with a chemical which expands upon heating to produce expanded graphite which comprises:
(a) a microwave or radiofrequency applicator with a chamber for expanding the intercalated unexpanded graphite;
(b) an internal rotatable plate for supporting the intercalated unexpanded graphite by the microwaves or radiofrequency waves;
(c) feed means at an upper portion of the applicator for feeding the intercalated unexpanded graphite by gravity onto the plate;
(d) wiper means mounted in the chamber for selectively separating the expanded graphite from the unexpanded intercalated graphite as the plate rotates;
(e) chute means leading from the chamber of the applicator for selectively removing the expanded graphite by gravity from the chamber which has been selectively separated by the wiper means; and
(f) a container for receiving the expanded graphite from the chute means.

7. The apparatus of claim 6 which provides continuous production of the expanded graphite between the feed means and the container.

8. The apparatus of claim 6 further comprising one or more speed control means for controlling residence time of the graphite in the chamber of the microwave or radiofrequency applicator.

9. The apparatus of claim 6 wherein the feed means comprises a vibratory-type feeder, gravimetric feeder, volumetric auger-type feeder, injector, flowing fluid suspension, dripping fluid suspension, blower, compressed gas feeder, vacuum feeder, gravity feeder, conveyor belt feeder, drum feeder, wheel feeder, slide, chute, or combination thereof.

10. The apparatus of claim 6 wherein the wiper A means comprises a stationary or moving wiper plate.

11. An apparatus for expanding unexpanded intercalated graphite in the presence of a gaseous atmosphere with a chemical which expands upon heating to produce expanded graphite which comprises:
(a) a microwave or radiofrequency applicator with a chamber for expanding the intercalated unexpanded graphite;
(b) feed means for feeding the intercalated unexpanded graphite into the chamber of the applicator;
(c) conveying means for moving the intercalated unexpanded graphite through the chamber while exposing the graphite to microwaves or radiofrequency waves generated by the applicator so as to expand the graphite to produce expanded graphite; and
(d) removing means leading from the chamber of the applicator to remove the expanded graphite from the chamber.

12. The apparatus of claim 11 wherein the feed means further comprises a feed rate control mechanism.

13. The apparatus of claim 11 wherein the conveying means further comprises a conveyor speed control mechanism.

14. The apparatus of claim 11 wherein the feed means comprises a vibratory-type feeder, gravimetric feeder, volumetric auger-type feeder, injector, flowing fluid suspension, dripping fluid suspension, blower, compressed gas feeder, vacuum feeder, gravity feeder, conveyor belt feeder, drum feeder, wheel feeder, slide, chute, or combination thereof.

15. The apparatus of claim 11 wherein the conveying means comprises a conveyor belt, rotating plate (carousel), auger (screw conveyor), gravity, aerosol cloud, dynamic air circulation, electric field, or combination thereof.

16. The apparatus of claim 11 further comprising a collecting means for receiving the expanded graphite from the removal means.

17. The apparatus of claim 16 wherein the collecting means comprises a bulk container, belt, wheel, sheet, fabric, fluid suspension, paste, slurry, vacuum bag, woven fibers, non-woven fibers, mat, or combination thereof.

18. A method for expanding unexpanded intercalated graphite in the presence of a gaseous atmosphere with a chemical which expands upon heating to produce expanded graphite which comprises:
(a) providing an apparatus comprising a microwave or radiofrequency applicator with a chamber for expanding the intercalated unexpanded graphite; feed means for feeding the intercalated unexpanded graphite into the chamber; sorting means in the chamber for differentiating between the expanded graphite and the intercalated unexpanded graphite; exit means from the chamber for receiving the expanded graphite from the sorting means with exclusion of the intercalated unexpanded graphite; and recycling means for retreating the intercalated unexpanded graphite in the chamber of the applicator;
(b) feeding unexpanded intercalated graphite into the feed means;
(c) exposing the unexpanded intercalated graphite in the gaseous atmosphere to microwave or radiofrequency energy in the chamber of the apparatus to produce the expanded graphite; and
(d) collecting the expanded graphite from the exit means.

19. The method of claim 18 which provides a continuous feed and expansion of the intercalated unexpanded graphite between the feed opening means and the exit means.

20. The method of claim 18 wherein the recycling means further comprises a speed control which can adjust the residence time of the graphite in the chamber of the microwave or radiofrequency applicator.

21. The method of claim 18 wherein the feed means comprises a vibratory-type feeder, gravimetric feeder, volumetric auger-type feeder, injector, flowing fluid suspension, dripping fluid suspension, blower, compressed gas feeder, vacuum feeder, gravity feeder, conveyor belt feeder, drum feeder, wheel feeder, slide, chute, or combination thereof.

22. The method of claim 18 wherein the sorting means sorts the expanded graphite from the expanded intercalated graphite based upon a size difference.

23. A continuous method for expanding unexpanded intercalated graphite in the presence of a gaseous atmosphere with a chemical which expands upon heating to produce expanded graphite which comprises:
(a) providing an apparatus comprising a microwave or radiofrequency applicator with a chamber for expanding the intercalated unexpanded graphite; an internal rotatable plate for supporting the intercalated unexpanded graphite by the microwaves or radiofrequency waves; feed means at an upper portion of the applicator for feeding the intercalated unexpanded graphite by gravity onto the plate; wiper means mounted in the chamber for selectively separating the expanded graphite from the unexpanded intercalated graphite as the plate rotates; chute means leading from the chamber of the applicator for selectively removing the expanded graphite by gravity from the chamber which has been selectively separated by the wiper means; and a container for receiving the expanded graphite from the chute means;
(b) feeding unexpanded intercalated graphite into the feed means;
(c) exposing the unexpanded intercalated graphite in the gaseous atmosphere to microwave or radiofrequency energy in the chamber of the apparatus to produce the expanded graphite; and
(d) collecting the expanded graphite from the container.

24. The method of claim 23 which provides continuous production of the expanded graphite between the feed means and the container.

25. The method of claim 23 wherein the apparatus further comprises a one or more speed control means for controlling residence time of the graphite in the chamber of the microwave or radiofrequency applicator.

26. The method of claim 23 wherein the feed means comprises a vibratory-type feeder, gravimetric feeder, volumetric auger-type feeder, injector, flowing fluid suspension, dripping fluid suspension, blower, compressed gas feeder, vacuum feeder, gravity feeder, conveyor belt feeder, drum feeder, wheel feeder, slide, chute, or combination thereof.

27. The method of claim 23 wherein the wiper means comprises a stationary or moving wiper plate.

28. A continuous method for expanding unexpanded intercalated graphite in the presence of a gaseous atmosphere with a chemical which expands upon heating to produce expanded graphite which comprises:
(a) providing an apparatus comprising a microwave or radiofrequency applicator with a chamber for expanding the intercalated unexpanded graphite; feed means for feeding the intercalated unexpanded graphite into the chamber of the applicator; conveying means for moving the intercalated unexpanded graphite through the chamber while exposing the graphite to microwaves or radiofrequency waves generated by the applicator so as to expand the graphite to produce expanded graphite; and removing means leading from the chamber of the applicator to remove the expanded graphite from the chamber;
(b) feeding unexpanded intercalated graphite into the feed means;
(c) exposing the unexpanded intercalated graphite in the gaseous atmosphere to microwave or radiofrequency energy in the chamber of the apparatus to produce the expanded graphite; and
(d) collecting the expanded graphite from the removing means.

29. The method of claim 28 wherein the feed means further comprises a feed rate control mechanism.

30. The method of claim 28 wherein the conveying means further comprises a conveyor speed control mechanism.

31. The method of claim 28 wherein the feed means comprises a vibratory-type feeder, gravimetric feeder, volumetric auger-type feeder, injector, flowing fluid suspension, dripping fluid suspension, blower, compressed gas feeder, vacuum feeder, gravity feeder, conveyor belt feeder, drum feeder, wheel feeder, slide, chute, or combination thereof.

32. The method of claim 28 wherein the conveying means comprises a conveyor belt, rotating plate (carousel), auger (screw conveyor), gravity, aerosol cloud, dynamic air circulation, electric field, or combination thereof.

33. The method of claim 28 wherein the expanded graphite is collected by a bulk container, belt, wheel, sheet, fabric, fluid suspension, paste, slurry, vacuum bag, woven fibers, non-woven fibers, mat, or combination thereof.

34. A method for expanding unexpanded intercalated graphite in the presence of a gaseous atmosphere with a chemical which expands upon heating to produce expanded graphite which comprises:
(a) providing an apparatus comprising a microwave or radiofrequency applicator with a chamber for expanding the unexpanded intercalated graphite;
(b) providing unexpanded intercalated graphite in the chamber of the apparatus in the presence of a gaseous atmosphere; and
(c) exposing the unexpanded intercalated graphite in the gaseous atmosphere to microwave or radiofrequency energy in the chamber of the apparatus to produce the expanded graphite.

35. The method of claim 34, further comprising the step of pulverizing the expanded graphite of step (c) to provide graphite platelets.

36. The method of claim 35, wherein the graphite platelets have a surface area of 50 m²/g or larger.

37. The method of claim 35, wherein the graphite platelets have a surface area of 75 m²/g or larger.

38. The method of claim 35, wherein the graphite platelets have a surface area of 100 m²/g or larger.

39. The method of claim 35, wherein the graphite platelets have an aspect ratio of 100 or higher.

40. The method of claim 35, wherein the graphite platelets have an aspect ratio of 1,000 or higher.

41. The method of claim 35, wherein the graphite platelets have an aspect ratio of 10,000 or higher.
